(19) United States
(12) Patent Application Publication
(10) Pub. No.: US 2024/0272037 A1
(43) Pub. Date: Aug. 15, 2024

(54) VALVE PERFORMANCE DETECTION SYSTEMS, PROCESSES, AND METHODS

(71) Applicant: TRUE ANALYTICS, LLC, Brooklyn, NY (US)

(72) Inventors: Daniel O'CONNELL, Minnetonka, MN (US); Seth WESTLAKE, St. Louis Park, MN (US)

(73) Assignee: TRUE ANALYTICS, LLC, Brooklyn, NY (US)

(21) Appl. No.: 18/440,467

(22) Filed: Feb. 13, 2024

Related U.S. Application Data
(60) Provisional application No. 63/484,789, filed on Feb. 14, 2023.

(51) Int. Cl. G01M 13/003; G07C 3/00

(52) U.S. Cl. CPC G01M 13/003; G07C 3/00

(57) ABSTRACT

A method may include obtaining data associated with a control valve. The data may be obtained using one or more sensors associated with the control valve. The method may also include performing an analysis corresponding to the control valve using at least the data. The method may further include generating a report using the analysis, the report including information associated with the control valve.

### CROSS-REFERENCE

This application claims the benefit of U.S. Provisional Application No. 63/484,789, filed Feb. 14, 2023, which application is incorporated herein in its entirety by reference.

### BACKGROUND

### Field

The present disclosure relates generally to valve performance, and more specifically, to detection systems, processes, and methods associated with valve performance.

### Background

Currently, in the valve diagnostic field, outputting variables and putting simple alarms like “deadband high” is the state of the art for monitoring the condition of a valve. Once the variable output or simple alarm is received, a user is responsible for determining what to do and how to proceed without an identification of the actual problem underlying the alarm, appropriate steps to debug the problem, and/or instructions on how to solve or correct the problem. Manual analysis of the variables is a common technique for valve analysis. Manual analysis of valve data can be negatively impacted due to the wide variation in training and experience of the person analyzing the data, the limited number of experts trained to identify problems, the lower overall diagnostic accuracy of the information (e.g., limitations of some mediums and/or limitations of accuracy of human analysis), and/or the extensive time required for a person to review and interpret all the data, and prepare a write-up of conclusions—which can takes days or weeks. Moreover, by the time a write-up of the conclusions is completed, the conclusions may be obsolete. The data and analysis can become obsolete for a number of reasons; for example, ongoing changes to the actual valve environment. Another common issue is that by the time information becomes available, the window of opportunity for taking action (e.g., adjusting valves) may be closed. As a practical matter, any required action likely involves a priority order for intervention which can negatively impact the ability to begin crucial repairs, for example, ordering of parts required for an intervention. There can also be a lack of clarity caused by the data interfaces. Onboard Diagnostics (e.g., bi-directional communication Highway Addressable Remote Transducer (HART) diagnostics) is typically able to detect ‘function’, but lacks either coverage in each instance or less diagnostic breakdown. For example, the frame of reference of the sensors may have limitations like those found in online diagnostics or positioner diagnostics, the system may not be programmed for or capable of providing more complicated analyses; and/or the diagnostics may simply not be as thorough as the diagnostics could be (e.g., the designer may not think to include certain analyses).

Examples of HART diagnostics are ‘is the electronic circuit still functioning’ or ‘do I have a low accuracy’ (which can have numerous causes of varying invasiveness to solve). Current online analysis solutions do not test before the valve is installed or test at a time when the valve can be repaired/replaced. Additionally, online analysis has shadows of data. For example, live data without movement does not provide insight into how the valve performs when the valve moves. Live data with only small movement also does not provide insight into valve performance with large movements. A full ramp test would better test for saturation and other core concerns like an improperly sized actuator. However, live monitoring raises concerns over the accuracy of measurement. Historical data stores can have low resolution, the sensors may not be calibrated or validated for accuracy, the sensors may not record all variables, and/or the measurement point may not accurately account for certain phenomenon (e.g., valve position is recorded on a ‘relative’ basis based on set stopping points). Those stopping points, if set incorrectly, mean the valve will not report the true goings on of the valve (this can be as much as a 50% error). Moreover, live monitoring does not provide breakdown by valve components or provides less coverage in each instance of valve components (significantly less sophisticated).

Traditional offline valve diagnostics are deficient because the offline valve diagnostics are typically carried out by maintenance groups within an organization, who often focus largely on function. For example, in some situations performance testing occurs but is limited and may be reserved for extremely sophisticated customer or a very limited number of valves (e.g., <1% of all valves onsite). There is no guarantee that the information reported by the maintenance group is also reported to the other groups in the organization that handle the control system that guides these valves to open and close. Moreover, the reported information is geared towards maintenance people, rather than towards control groups. The control group, on the other hand, is responsible for managing the valve performance before startup or while the valve is online. Failing to provide actionable information to the control group, results in the control group performing additional work compared to the work that would be performed if the information needed was available at the outset. Performing additional work takes away from other projects at the plant and reduces the overall organizational efficiency. Eliminating unnecessary work, provides the control group time to work on other projects to improve performance of the overall plant.

Valves can be connected to a distributed control system (DCS). A DCS is a computerized control system for a process or plant, usually with many control loops in which autonomous controllers are distributed through the system but there is no central operator or supervisory control. The DCS integrates information about a plant facility (e.g., how hot is a particular part, how much chemical X is flowing through the system, etc.) and based on algorithms, the DCS adjusts operation of final control elements (valves, motors—anything that can move to impact how much or how little of something is happening). How a target valve responds to the DCS is based on the inputs available and is called “control tuning”. Control tuning is a series of values and equations that determine a desired position of the target valve given the inputs of the system (and the response of the target valve to those inputs). When performance of a valve is changed, or a new valve is installed, performance of the valve changes which can change the overall system performance. Consequently, the control tuning placed in the system may or may not be sufficient in view of the change in valve performance. The change in performance or valve can be further complicated by advancements in technology. A digital positioner, for example, has its own ‘control tuning’ internal to signals the digital positioner receives. The internal signal creates a scenario in control tuning known as cascade control. Cascade control has its own rules for ideal response. For example, attempting to tune a system that is subject to cascade control from internal signals as if the system is not in a cascade control situation will result in sub-optimal control. One solution is to disable advanced features of positioners causing the cascade control.

FIG. 1 depicts an output of live monitoring of data over time with no valve movement 100. As will be appreciated by those skilled in the art, a limitation of live data monitoring is that it can only provide information based on the required movements during process control. Some valves are kept closed except for very limited occasions, or are kept at a certain % open with little variation. This limits the amount of information we can use to infer the performance of the valve if it had to move. For example, there is no guarantee that a valve that has been kept closed for a year will successfully open when requested. The y-axis is position (%).

FIG. 2 illustrates an output of live monitoring data shadows over time with valve movement 200. A limitation of live data monitoring is that it can only provide information based on the required movements during process control. If a process only requires valve movement in a limited range, then the analytics will only provide estimated information based on the limited range of movement. If there are performance issues in other movement ranges, such as galling or a damaged seat, then those performance issues will go undetected. The y-axis is position (%).

FIGS. 3-5 illustrate test results for a valve operating of a full range of movement.

Turning now to FIG. 3 a stroke testing with galling over a partial range are illustrated. The data is illustrated as an output of percentage of travel over time (in seconds) 300 for increasing signal and decreasing signal. The results depicted are an example of a valve that has a significant degenerative condition, known as galling, in the lower half of its range of operation. This particular process was operated in the upper half, so the facility was unaware there was a major performance issue. As galling is a degenerative condition, the valve required replacement to prevent the issue from eventually affecting the active range of operation. As would be appreciated by a person of skill in the art, a reason to conduct testing over the full range of the valve is to uncover issues that are significant but have not yet progressed to ranges the process requires.

FIGS. 4A-B illustrates a stroke testing with a mis-sized actuator showing percentage of travel over time. In FIG. 4A, the data illustrates travel and positioner as percentage of travel over time (from 0-125 seconds) 400 for increasing signal and decreasing signal; and

FIG. 4B illustrates an output for an actuator as pressure (psi) over time (from 0-125 seconds) 410. A double acting valve has two air chambers: a top chamber and a bottom chamber. When the pressures in the air chambers are changed, the position of the valve change is changed. The actual position of the valve stem dictates how open or closed the valve is. In this instance, the actuator data did not saturate at the ends of valve travel, which is an indicator that the actuator is mis-sized (e.g., the air chambers have more volume than required). This mis-size was contributing to significant performance issues in the application. However, those performance issues are not visible in the mid-range operation of the valve - only the ends of the valve movement.

FIG. 5 illustrates partial stroke testing with seating issues. The data illustrates travel as a percentage over time (from 0-200 seconds) 500, for an increasing signal and decreasing signal with the increasing signal and decreasing signal largely overlapping over the 200 seconds. As will be appreciated by those skilled in the art, the benefit of operation over a full range is that such tests often uncover performance issues that are significant but have not yet progressed to impact performance at the movement ranges the process requires. This is an example of a valve with a seating issue. This valve caused no issues during regular operation. However, after a plant shutdown, the valve caused issues when the plant attempted to start up again from the closed position. A regular review of the full range of valve performance would catch such an issue.

FIGS. 6-9 illustrate examples of digital positioner diagnostic output from different valve manufacturers 600. As will be appreciated by those skilled in the art, different manufacturers present information about the valves in different formats. As will be appreciated by those skilled in the art, the output does not provide any analytical insight. The examples in FIGS. 6-9, only illustrates data and values without any insight.

Turning now to FIGS. 6A-B, a positioner diagnostic output created by a valve manufacturer is illustrated, including: an actuator signal (% valve movement (i.e., percentage of range of movement of the valve) over pressure range (kPa)), Extended/High Resolution of the valve (% valve movement over pressure range (kPa)), Step Response Test (% valve movement over time (s)), and positioner signature (% valve movement over input signal (%)). FIGS. 7A-B are an example of a positioner diagnostic output from a positioner created by a different valve manufacturer. FIGS. 8A-B are an example of a positioner diagnostic output created by yet another valve manufacturer. The valve signature output looks at actuator pressure over valve travel, valve travel over percent input, and percent drive signal over percent input. FIG. 9 illustrates an example of a positioner diagnostic output created by still another valve manufacturer and includes, for example, signals vs. command data. FIGS. 10A-D illustrate an offline diagnostic system output with examples of a valve

signature output from a specialized offline diagnostic machine. A benchmark of overall valve performance is provided showing a distance from seat-degrees (y-axis) and control signal-mA (x-axis) 1010 in FIG. 10A, a supply pressure response showing a supply pressure-psg (y-axis), and a control signal-mA (x-axis) 1020 in FIG. 10B, an actuator performance showing top pressure-psg (y-axis) and control signal-mA (x-axis) 1020 in FIG. 10C, and valve positioner performance showing distance from seat-degrees (y-axis) and control signal-mA (x-axis) 1040 in FIG. 10D.

FIG. 11 illustrates an example of a supplementary valve signature output from a specialized offline diagnostic machine 1100. FIGS. 12A-B illustrate an example of a valve signature output from a different specialized offline diagnostic machine 1200.

FIG. 13 illustrates an example of a same-direction or “sensitivity” test 1300 showing a signal (from 48-52%) over time (from 0 to 100 seconds). Typical of any manufacturer of offline or positioner diagnostics. FIG. 14 illustrates an example of an alternating-direction or “resolution” test typical of any manufacturer of offline or positioner diagnostics 1400. In this illustration the signal is illustrated from 49.5 to 55.5% over time from 0 to 180 seconds. There are other diagnostic tests that test valve accuracy in different ways, but the output looks similar to the above examples.

FIGS. 15A-B illustrate an example of a static diagnostic path report 1500. As evident from this report, the current state of the art would be to issue alarms that detect descriptions of performance anomalies, rather than identify the root cause(s) of any identified performance anomalies. It is worth noting that all prior examples from manufacturers did not always provide meaningful numbers of descriptions, and often required the user to perform a lot of analysis with limited data visualization to ultimately identify the source of a problem. While these examples are an improvement over previous solutions, these examples also do not meaningfully reduce the amount of information an individual needs to know to diagnose problems with valve performance. While the report might expand available information and the information readily available, the information still only provides a high level view. In the example shown in FIGS. 15A-B, there are at least six graphs, a number of checks to follow, and each check has a significant amount of information and recommendations to narrow the root cause down.

FIGS. 16A-C illustrates an example of a static diagnostic path with detailed text illustrating an example of critical recommendations 1600, 1610. Example descriptions of ‘helpers’ are provided for alarms. Note that the write-up does not identify all issues that were active on the test, what the test results mean, or all possible outcomes for the test results. The examples in FIGS. 15A-B and 16A-C illustrate and describe only a couple of issues among what could be many issues in previous approaches. Further, the prior approaches may include invasive operations (e.g., may result in significant downtime in an associated system), may provide extraneous and/or non-essential recommendations (e.g., recommendations that may not address a root cause of an issue).

What is needed are processes, systems and methods that provide diagnostic information for the cause of a failed or failing device performance, including sensor performance, information on how to debug the problem and/or how to solve or correct the problem. Additionally, what is needed are processes, systems and methods that provide diagnostic information for the cause of a failed or failing device performance, including sensor performance, information on how to debug the problem and/or how to solve or correct the problem that is delivered dynamically.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

Disclosed are processes, systems and methods that may provide diagnostic information associated with a cause of a failed or failing device performance, including sensor performance, information on how to debug the problem or issue, and/or how to solve or correct the problem or issue. The disclosed systems, processes and methods may provide information and/or diagnostic aids about the cause of a problem or issue and one or more steps that can be taken (invasive and/or non-invasive) based on the identified cause to investigate (if needed) the problem or issue. The disclosed systems, processes and methods also provide information about how to mitigate, reduce, and/or solve any identified problems or issues. For example, the investigations may provide someone a step-by-step process to further identify what they should do or what recommended action item may be best. Additionally, an estimated severity of an identified issue can be provided to assist in prioritizing solutions.

Alternatively, or additionally, each identified problem or issue may be referenced against other problems or issues and the correlated problems or issues may be used to eliminate unlikely causes for the problem or issue. This correlation and analysis step may avoid attempting or deploying solutions that may not be likely to improve performance and/or solve an identified problem or issue. Alternatively, or additionally, the processes, systems, and method may be operational to identify a likelihood and level of invasiveness for any solution that might be required in a particular situation. Thus, for example, a user may utilize the processes and/or systems described herein to determine whether a simple repair may resolve the problem or issue, or whether extraordinary efforts may be required, such as ‘get a crane and take the entire valve out of the line.’

By detecting valve issues early, the processes, systems and methods described herein may correct, prevent, and/or eliminate lost performance that may be critical to plant profitability. Alternatively, or additionally, detecting valve issues early may correct, prevent, and/or eliminate reliability issues that might otherwise result in a shutdown of all, or part, of a plant, and may allow for scheduling repairs at a time that may reduce or eliminate overall impact for a facility. Importantly, early detection of valve issues may prevent potential safety issues.

The disclosed systems, processes, and methods may utilize additional data regarding the importance or criticality of a valve to further sort the identified proposed actions in a prioritized order across multiple valves. Utilizing additional data regarding the actual performance of the valve while performing movements of various sizes to recommend additional actions for solving, correcting, and/or mitigating an identified problem, and/or further refine information regarding display of proposed actions. The additional data regarding the required performance of the valve can also be used to further refine, sort, or select proposed actions (in a prioritized order or unordered).

One configuration of the disclosed systems, processes, and methods may refine identification of root causes and/or may resolve root cause selection between identified issues with similar diagnostic signatures. For example, if the root cause is likely one of X, Y, or Z, determining whether the root cause may be X or Z can be determined by further: (1) determining if a repair may be involved, (2) determining whether a minor adjustment may be implemented (e.g., changing a setting on a digital device), or (3) determining if a larger adjustment may be implemented prior to further debugging efforts. As will be appreciated by those skilled in the art, the user may be asked and/or directed to take non-invasive steps to further identify similar diagnostic signatures that may be present in the system. The requested adjustment may not be required to fix the root cause, but may be required to identify the root cause. For example, a test to determine if the root cause is X or Z.

The systems, processes, and methods described herein may be operable to provide recommendations for specific improvement paths and/or for specific repairs to be performed on each valve component. Direct or indirect readings of the shaft or data readings, such as readings from the positioner, may be used for analysis by the system. Data may also be readings of pressures, friction, currents, signals, and/or other analytical sensor outputs. Alternatively, or additionally, data and/or data readings can be obtained from a distributed control system, a data historian of process data from a facility, and/or data to or from an independent measuring system separate from the valve.

Alternatively, or additionally, the system may use high accuracy, traceable-calibration

sensors. The analysis of a valve may be performed over the entire span of valve travel or only partial ranges of travel, as may be appropriate under a particular process. Alternatively, or additionally, alternate tests can be performed, including tests of alternating step performance, same-step performance, step speed performance, hysteresis, and/or deadband. Tests can be performed while a target valve under evaluation is in a state where repairs may be possible or the valve may be removable from piping. Alternatively, or additionally, tests can be performed while the target valve under evaluation may be in active use by the system. The systems, processes, and methods may be operable to perform analysis on performance, system, device, and/or valve data collected recently (e.g., by tests performed) and/or historically.

The disclosed systems, processes, and methods may be operable to take the information from one or more valve tests that measure performance and provide outputs to dynamically propose issues that may resolve valve performance and the issues necessary to resolve for valve performance to be properly aligned with control system settings. This process may be applied to static test data output. As will be appreciated by those skilled in the art, a particular valve in a system can have higher performance than the plant facility may require and the plant facility can still have sub-optimal performance with the items controlled by the plant facility. As an example, in instances in which the plant facility attempts to switch from analog to digital positioners and does not ensure control tuning is adjusted to match, a sub-optimal performance can result. Sub-optimal performance can also occur if a new or repaired valve in a plant facility suddenly performs vastly better than the performance of the old or pre-repaired valve. A valve can also perform worse than a target performance for a plant facility and it would be useful for the plant facility to know that performance was below a target in order to adjust performance strategies accordingly. A valve can also perform worse than a plant facility target performance, but only in specific ranges and/or during specific tasks (e.g., high friction for part of the valve travel). Consequently, it may be useful for a plant facility to be alerted to performance of a valve below a target in order to adjust performance strategies accordingly.

In one embodiment, a breakdown of the tests, including alternating step, same-direction step, speed performance, hysteresis, and/or deadband, may be provided. The breakdown of speed performance can be by step-size, response time (e.g. dead-time), time to 63% response (T-63), time to 87% response (T-87), settling time, and/or other representations of change over time. Information regarding accuracy by step-size may be provided to the user.

Alternatively, or additionally, information regarding overshoot or other abnormalities in detected response may be provided to the user. When known deficiencies in valve design and/or performance are identified or detected, information about the impact of the deficiencies may be provided. Alternatively, or additionally, for example, when a digital positioner impacts, or is projected to impact, a control response, information about the impact may be provided. Information can also be provided using the same or separate dynamic-issue-generation process as other elements of the disclosed systems, processes, and methods. Additional information may be provided to technicians and/or users to identify how their responsibilities relate to what the control rooms may need for improving and/or optimizing performance. In some configurations, information can be separated from information provided to a control room such that technicians may receive a first set of information and the control room may receive a second set of information, all or some of which might overlap the first set of information.

In an embodiment, a method may include obtaining data associated with the control valve. The data may be obtained using one or more sensors associated with the control valve. The method may also include performing an analysis corresponding to the control valve using at least the data obtained. The method may further include generating a report using the analysis. The report may include information associated with the control valve.

In another embodiment, a system may include a control valve, one or more sensors, and a computing device processor. The sensors may be operable to obtain data associated with the control valve. The computing device processor may be operable to perform an analysis corresponding to the control valve using at least the data from the sensors. The computing device processor may also be operable to generate a report using the analysis. The report may include information associated with the control valve.

In another embodiment, a system may be operable to provide an experience and the system may include a processor, a non-transitory computer-readable medium, and stored instructions. The stored instructions may be translatable by the processor and may be operable to perform one or more operations. The operations may include obtaining data associated with a control valve using one or more sensors associated with the control valve. The operations may also include performing an analysis corresponding to the control valve using at least the data obtained. The operations may further include generating a report using the analysis, where the report may include information associated with the control valve.

Both the foregoing general description and the following detailed description are exemplary and explanatory only and are not restrictive of the disclosed embodiments, as claimed.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

Capaci et al. published Dec. 9, 2017 for Review and Comparison of Techniques of Analysis of Valve Stiction: from Modeling to Smart Diagnosis;

Korean Patent KR100713621B1 issued Aug. 10, 2007 for Methods for Testing Performance of Current Air Driven Type Control Valve;

Korean Patent Publication KR20190019369A published Feb. 27, 2019 for Pneumatic control valve failure diagnosis method;

U.S. Pat. No. 8,768,631 issued Jul. 1, 2014 for Diagnostic method for detecting control valve component failure;

U.S. Pat. No. 8,955,365 issued Feb. 17, 2015 for Performance monitoring and prognostics for aircraft pneumatic control valves;

U.S. Pat. No. 9,037,281 issued May 19, 2015 for Method and apparatus for condition monitoring of valve;

U.S. Pat. No. 9,727,433 issued Aug. 8, 2017 for Control valve diagnostics

U.S. Pat. No. 10,851,814 issued Dec. 1, 2020 for Valve signature diagnosis and leak test device;

U.S. Pat. No. 11,378,108 issued Jul. 5, 2022 for Method and apparatus for diagnosing pneumatic control valve by using positioner model;

U.S. Pat. No. 11,434,839 issued Sep. 6, 2022 for Use of machine learning for detecting cylinder intake and/or exhaust valve faults during operation of an internal combustion engine;

US Publication US 2020/0386654 A1 published Dec. 10, 2020 for Test Device and Test Method for Dynamic Characteristics of Spring-loaded Safety Valve; and

US Publication US 2021/0123543 A1 published Apr. 29, 2021 for Valve State Grasping Method and Valve State Grasping System.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates an output of live monitoring data shadows with no movement;

FIG. 2 illustrates an output of live monitoring data shadows with valve movement over a range;

FIG. 3 illustrates an output of stroke testing over a partial range;

FIGS. 4A-B illustrate an output of stroke testing with a mid-sized actuator;

FIG. 5 illustrates an output of showing limitations of partial stroke testing with seating issues;

FIGS. 6A-B illustrate an example of positioner diagnostic output;

FIGS. 7A-B illustrate an example of a positioner diagnostic output;

FIGS. 8A-B illustrate a positioner diagnostic output;

FIG. 9 illustrates a positioner diagnostic output;

FIGS. 10A-D illustrate an offline diagnostic system output;

FIG. 11 illustrates an offline diagnostic system output;

FIGS. 12A-B illustrate an offline diagnostic system output;

FIG. 13 illustrates an example output of a same direction step test;

FIG. 14 illustrates an example output of an alternating direction step test;

FIGS. 15A-B illustrate an example output of a static diagnostic path;

FIGS. 16A-C illustrate an example output of a static diagnostic path;

FIG. 17 illustrates an example output of a dynamic improvement path summary;

FIGS. 18A-B illustrate an example output of an expanded dynamic improvement path summary;

FIG. 19 illustrates an example output of a dynamic improvement path investigation phase;

FIGS. 20A-B illustrates a comparison of measurement outputs between offline measurement at bottom of shaft vs. positioner;

FIGS. 21A-B illustrate a comparison of measurement outputs between offline measurement at bottom of shaft vs. positioner;

FIG. 22 illustrates raw data before normalization and analysis using a stair-stepping algorithm with increasing position data;

FIG. 23 illustrates output following analysis with a de-trended stair-stepping algorithm;

FIGS. 24A-E illustrate output to a control system alignment module;

FIG. 25 illustrates output of live monitoring data with a square tooth saw pattern;

FIGS. 26A-B illustrate an example of HART Diagnostic outputs;

FIG. 27 illustrates a process that includes applying dynamic improvement path summaries;

FIG. 28 illustrates a flowchart of a stair-stepping algorithm;

FIG. 29 illustrates a flowchart of a function scoring algorithm;

FIGS. 30-31 illustrates an output of improvement path summaries with cross-test data; and

FIG. 32 illustrates a static analysis with cross-test data.

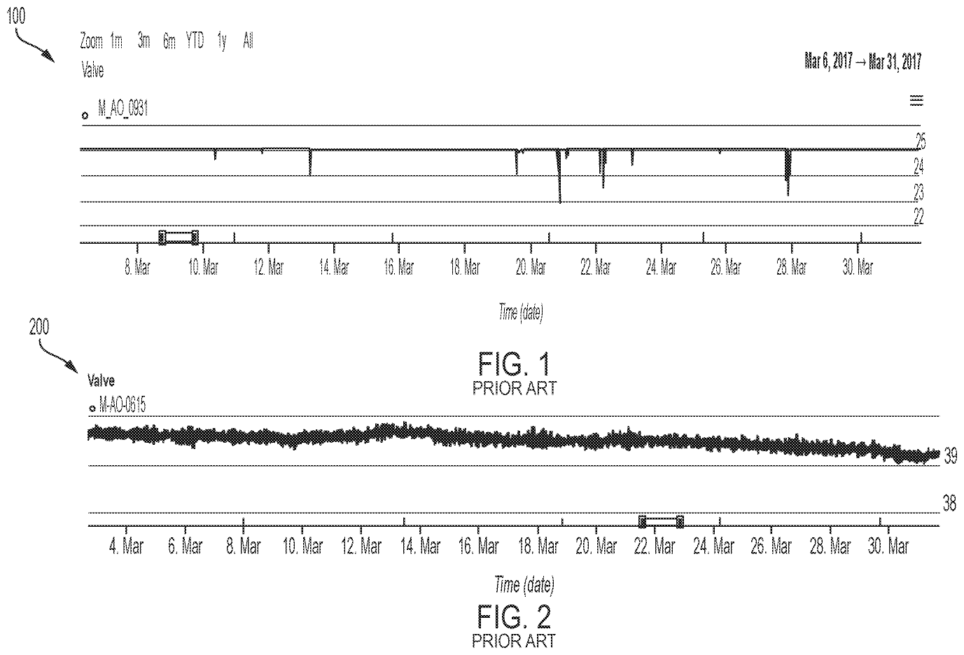

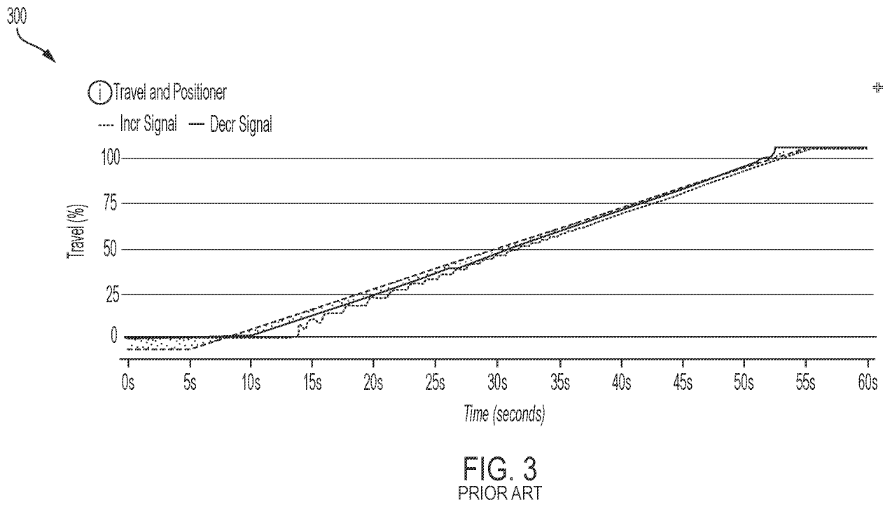

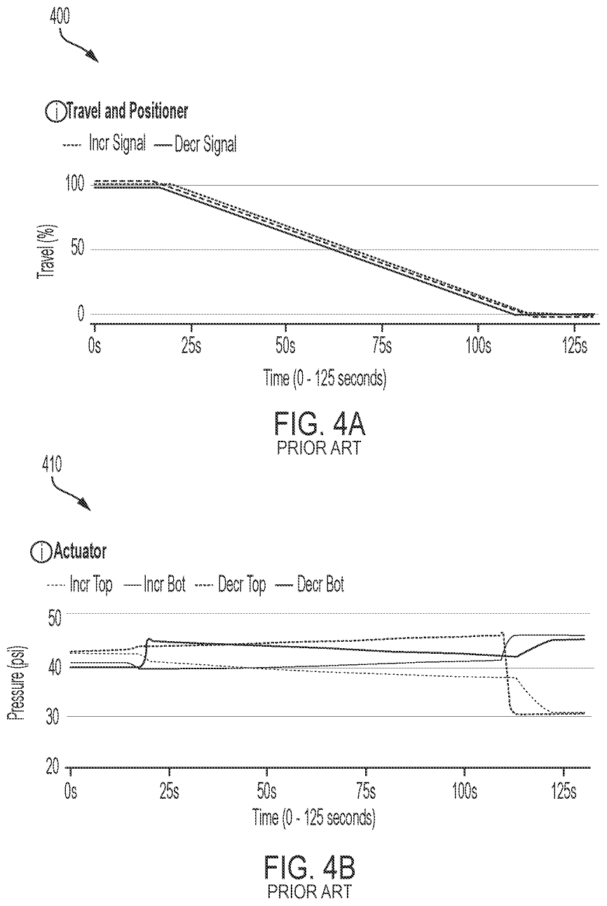

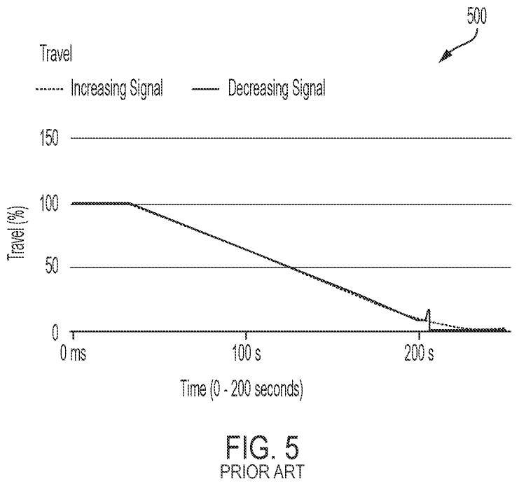

### DETAILED DESCRIPTION

### I. Data and Analysis

One or more run analyses may be performed on the valves. Run analyses may be models that may vary in complexity and/or target operational information to identify. Some run analysis models may be simple and/or some run analysis models may be related. For example, knowing the friction is “low” may eliminate symptoms that may be more likely due to friction being high for any valve component.

As an example, a basic model may be operable to detect various archetypical issues, such as weak or incorrect springs, correct failure/air actions, correct signal span, whether the valve is packed, whether positioner performance is acceptable, etc. However, for issues that may be related, the system may be operable to, for example: (1) know that high friction may affect the boundaries for detecting poor positioner performance; (2) determine whether certain anomalies in positioner performance (e.g., crossover, high noise) can affect root cause analysis - particularly when correlated with the same effect in other signals; (3) know whether the calibration is correct or incorrect, which can affect diagnosis of issues that may happen when an air chamber (e.g., a valve actuator chamber) may be expected to be at saturation (e.g., seat exit, whether issues at saturation may be caused by calibration, etc.); and (4) know that in instances in which positioner cutoffs are activating early, analysis of certain root causes at the seat should be disabled or altered (e.g., due to being forced into the seat early by the signal cutoff settings). As will be appreciated by those skilled in the art, the system may be operable to address other issues as well.

Alternatively, or additionally, an output analysis can be performed on the valves. The output analysis can use multiple pieces of information. The output analysis can be used to identify performance issues the valve may be experiencing or projected to experience (e.g., the valve positioner may be performing poorly). Identifying performance issues may provide users with actionable information that may be more useful than a generic statement, such as “the test shows the dynamic error is high.” Additional output, which may be provided based on the analysis, may identify how to investigate the identified issues (if necessary) to determine a next action. The output can also identify action items that may be recommended to reduce or eliminate the identified issue. For example, recommendations can be made depending on how invasive the proposed action items may be—is the proposed action a simple adjustment, does the proposed action require new or replacement parts, does the valve need to be sent out for repair, how likely are the proposed action items to resolve the identified issue, and so forth. Additional contextual feedback can be provided, for example, “nine times out of a ten a valve with this data has [problem identified] as the root cause.” This additional contextual feedback may allow users to determine whether the proposed action is very likely, likely, possible, or unlikely to resolve a performance issue. Each of these components may be delivered dynamically; delivery of the information may prioritize, elevate, and/or eliminate recommendations and action items for each identified issue in response to ongoing data. Dynamic delivery may allow the user to quickly identify the most likely choices and outcomes.

Data may be obtained from a system that provides a “valve signature.” The valve signature may be obtained via a valve signature test where the signal for the valve may increase linearly from 0% to 100%, then decrease from 100% to 0% over a slow period of time. An extension of the valve signature test may be to run a ‘partial test’, which may range from X% to Y%, where X% is greater than or equal to 0% and less than Y%, and Y% is less than 100%. For example, a partial test could range from 0% to 20%. The valve signature test may also be referred to as a baseline test, a profile test, a signature test, a quasi-static test and/or other terms related to a test to determine a valve signature, where “valve signature test” used in the present disclosure may refer to any of the above described tests. The valve signature test can include one or more sensors operable to check parts of the valve, including but not limited to valve stem position, air supply pressure (e.g., air supply pressure measurement), actuator air pressures (e.g., actuator air pressure measurement), signal, etc. The system may be operable to be onboard the valve itself or in a component of the valve (e.g., the “positioner”), or the valve signature test could be administered from a separate system that tests the valve independently. Alternatively, or additionally, the data can be obtained from a data historian or DCS. The increasing time, decreasing time, or hold time associated with the valve signature test can also be flexible. The analyses that may follow the valve signature test may be “on-board” the device performing the valve signature test. In some configurations, data can be used from an alternating step test, a same direction step test, a test of step speed (or step speed test), a hysteresis test and/or a deadband test. These tests can be of varying step sizes, orders, and/or lengths (in time). In some instances, one of several standardized sets of parameters may be used. As will be appreciated by those skilled in the art, conclusions from these tests may differ and may be less specific to parts. However, this data may be important for determining if the valve may be performing adequately from a ‘financial’ point of view. This data may also be important for purposes of ensuring valve performance may be matched to control system performance.

Valve analysis data can also be obtained from gathering data from an alternating step test, a same direction step test, or a test of step speed. The run analysis described above can also be performed. Unlike an analysis performed to determine whether the valve may be performing optimally, the run analysis may be designed to talk about the valve “as it is.” For example, if the valve is left in an “as is” condition, what would a control room need to know? In some instances, cases that may be borderline unacceptable or likely to have an impact on, for example, valve performance if left alone for years at a time, may be highlighted so those performance issues can be addressed proactively (e.g., before a problem may arise). This may also be true for valve performance, control room performance, etc.

Alternatively, or additionally, the output analysis described above can be performed. Multiple pieces of information, such as from the run analysis, may be used in the output analysis. For example, what may be the expected application performance of the valve? In considering what information may be important about that expected performance as it relates to setting up the loop, the following may apply:
The response accuracy and speed across steps may be summarized (e.g., the valve doesn't respond well below 2%), rather than providing large amounts of data a person would have to process to determine a conclusion based on the large amounts of data.
Are there any abnormalities that may impact control of the valve operation, such as does the valve have overshoot, do the steps settle or are still fluctuating after reaching the target value?
Are there any characteristics of the valve that would impact the control of the valve operation, such as loose linkages or use of a digital positioner with I/D gains?

The above items can still be shown as issues, among other methods identifying: how to investigate identified issues (if necessary) to determine the best action to take; what action items may be recommended to reduce or eliminate the issue; how ‘invasive’ those action items may be (e.g., “is this a simple adjustment, does it require parts, does the valve need to be taken to a repair shop”, etc.); and/or how likely those action items may be (e.g., “nine times out of a ten a valve with this data has this as the root cause”). The summary may be displayed for the user using one or more categories, such as very likely, likely, possible, and/or unlikely. Each of the issues and actions may be ‘dynamic’ and may not be presented in an on/off status. The issues and action may be generated, prioritized, elevated, and/or eliminated on a real-time or near real-time basis as data may be received, changed, and/or investigation steps and action items concluded. Individual issues may be displayed to provide the user with actionable information regarding likely choices and outcomes based on the information. Analysis may be performed and a report generated in real-time or near real-time.

### II. System Process for Dynamic Data Optimization

The disclosed systems, processes, and methods may obtain position data from a system that provides a “valve signature” using one or more data collection mechanisms or methods. The position data may be obtainable from a test where, for example, the signal for the valve may increase linearly from 0% to 100% and then may decrease from 100% to 0% over a slow period of time. The position data test can also have hold times between a test start, signal switch, and/or test end. In some configurations, the position data test can be configured to run one way. Alternatively, or additionally, the position data test may be separated into two tests that may have the results thereof stitched together. An extension of the position data test may be to run a ‘partial test’, which may range from X% to Y% (e.g., any range between 0% and 100%). The position data test may include sensors checking one or more valve parts, including, but not limited to, valve stem position, air supply pressure, actuator air pressures, friction, signal, etc. The systems and processes may also be operable to onboard the valve itself or in a component (usually the “positioner”), or data could be obtained from a separate system that tests the valve independently. The systems may be operable so that the analysis is performed on-board the device, or performed on a remote device that has received the test data.

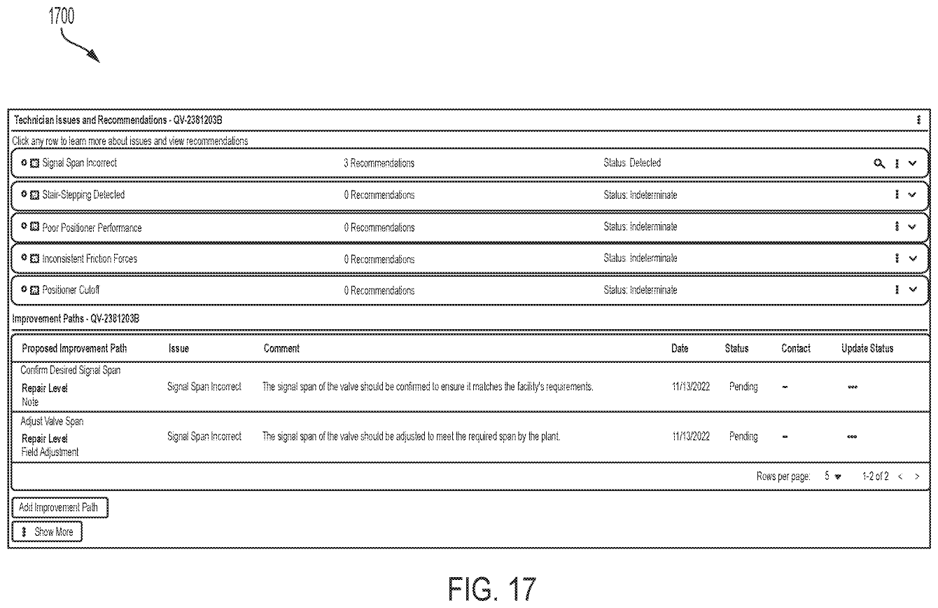

FIGS. 17-19 illustrate an output for dynamic analysis processes, e.g., dynamic improvement path summary 1700, 1800, and dynamic improvement path investigation phase 1900. The dynamic analysis processes may reduce the information presented to a user and may present the information in a hierarchical fashion that may identify more important issues before less important issues, along with possible actions for the potential issues. Issues that may be indeterminate in view of the valve settings may be listed separately. Actions that may result in improved performance may be readily ascertainable for each issue. The output analysis illustrated in FIGS. 17-19 may be operable to compile over 100 checks into 30 or more root causes. It will be appreciated that more or less checks may be compiled into more or less root causes than described, without departing from the scope of the disclosure. Notably, the analysis may not show the user information that may be deemed unnecessary for decision making relative to the issues. From the analysis, data that the user may need to make a decision may be available and/or displayed to the user. Alternatively, or additionally, for example, the following information can be changed dynamically: the priority of the issue; whether an issue may be determined or may be indeterminate (e.g., whether or not the cause of the issue may be identified); the description; the accessory information; the investigation steps (e.g., actions that may narrow down improvement paths non-invasively); the available improvement paths (e.g., what actions can be taken, the invasiveness of the actions, likelihood the actions may be needed, and/or a pre-generated description of the action so the user need not write out details); sensor data; and/or graphical output. Diagnostic information may be processed to identify the issues that may be unable to be determined, such as due to issues including incomplete data and/or confounding factors. The graphical summary of the data may allow the user to quickly understand the investigation path. The dynamic output may also improve clarity and/or timeliness for the user. As a failsafe, the state of the art static diagnostic can be supplied should the user wish to check any element of the process by hand in a more friendly fashion than the raw diagnostic output. Once the dynamic data is delivered, the user can review identified items and then make decisions and take appropriate actions. Alternatively, or additionally, in some instances, there may be only one recommendation or action item. In some cases, the system may be operable to require the user to review the data and actively confirm it is correct (e.g., the system may cause the user to scroll through the recommendations or action items and/or the system may cause the user to input a confirmation that the data is correct, such as selecting a checkbox).

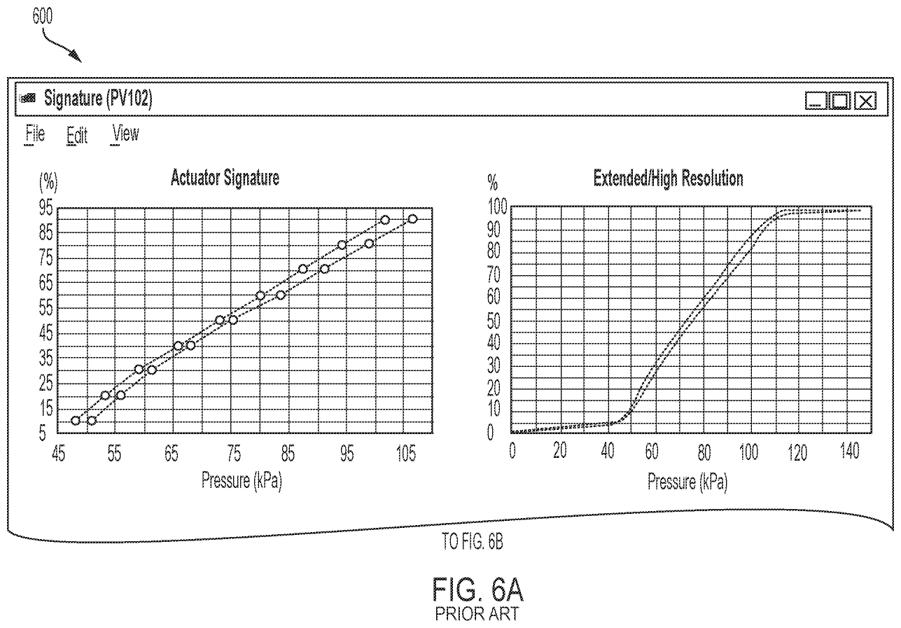

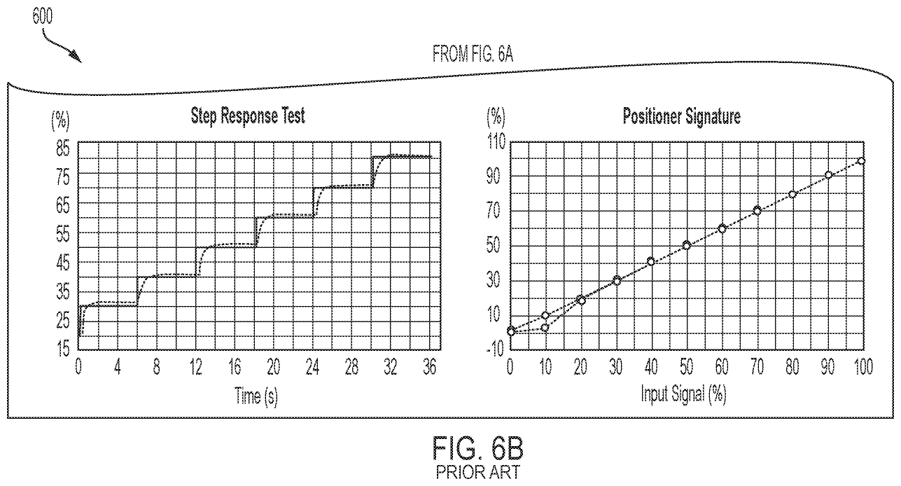

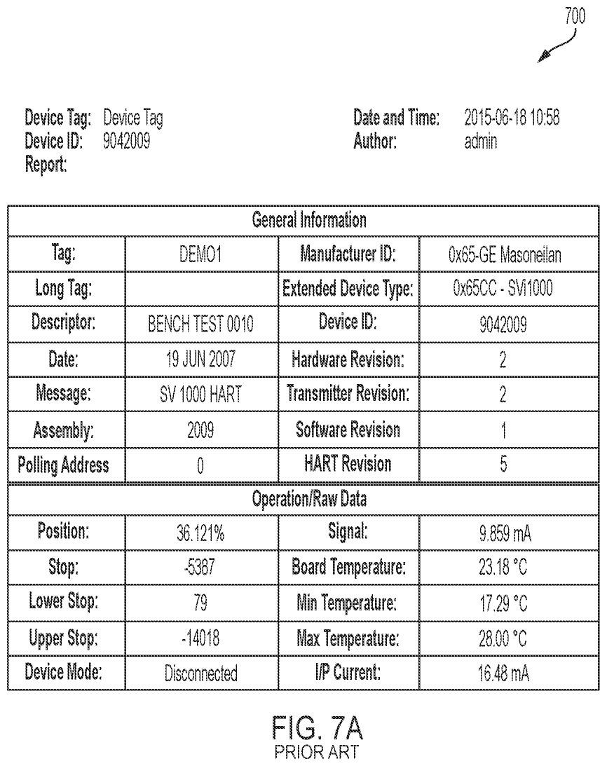

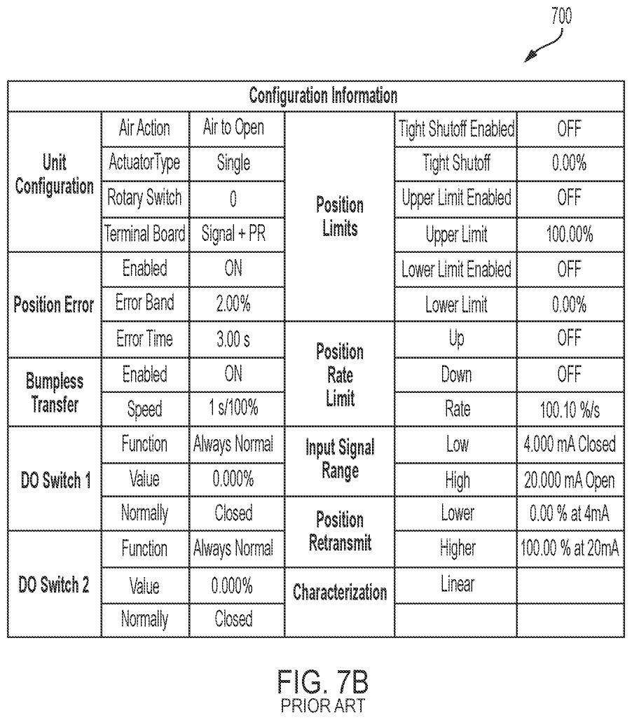

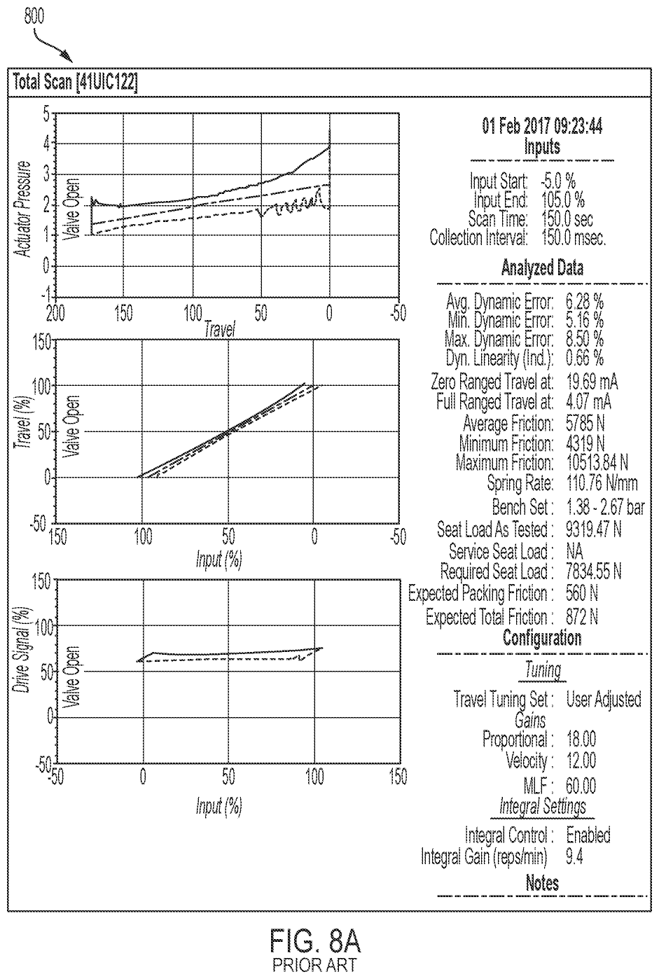

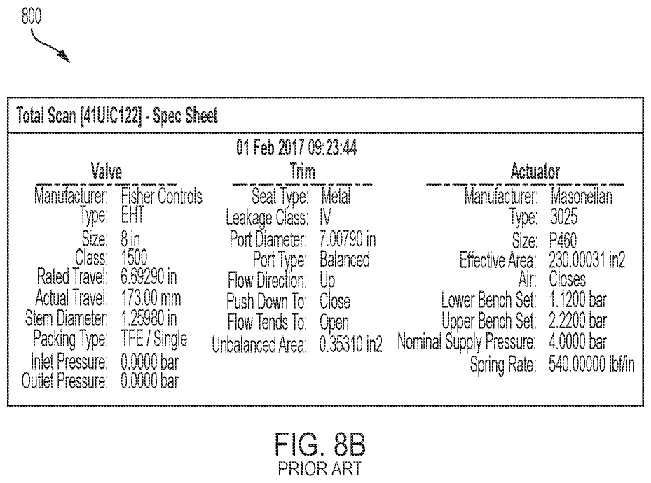

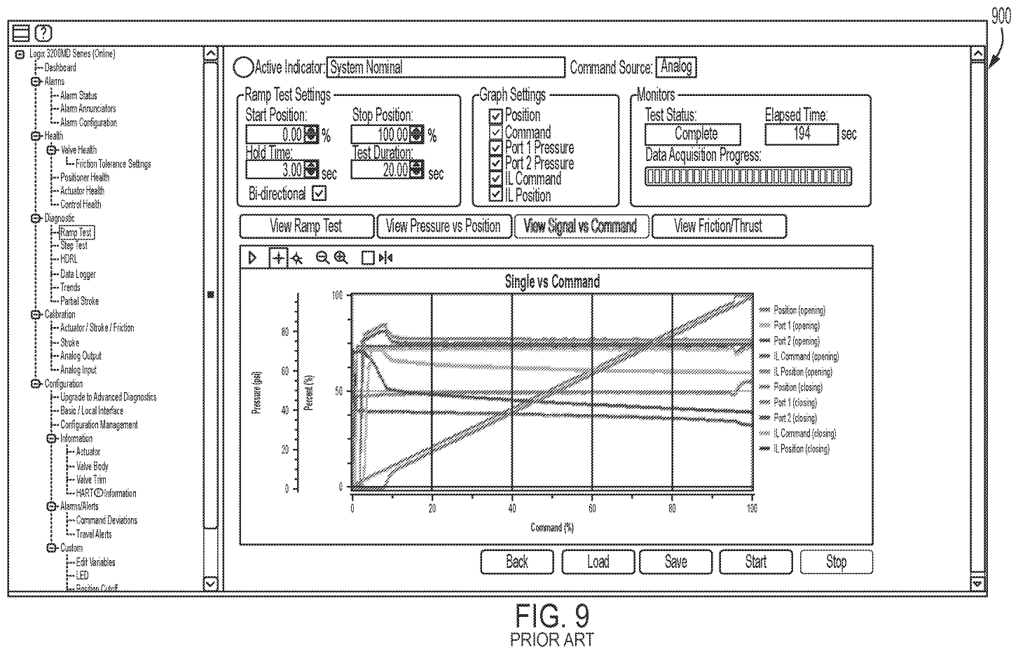

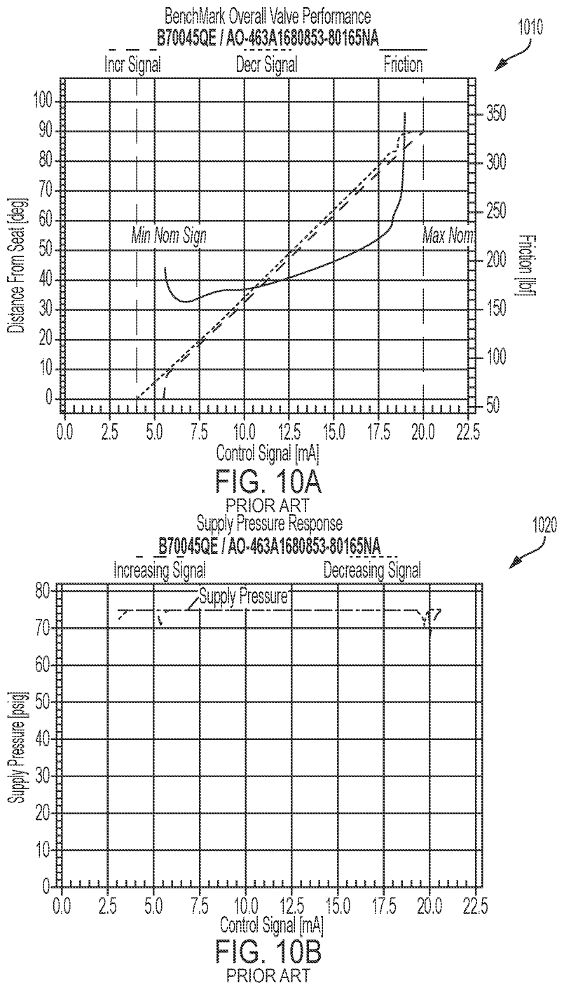

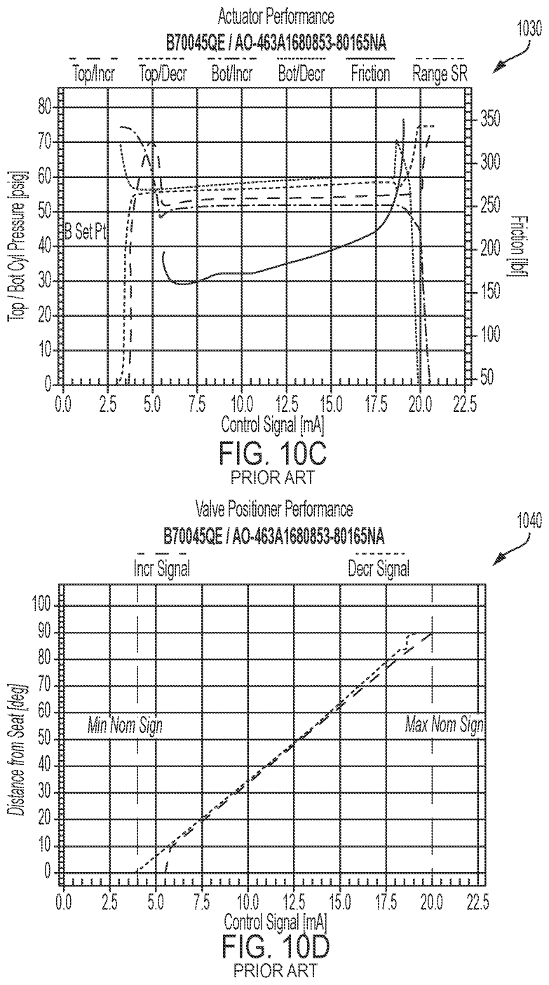

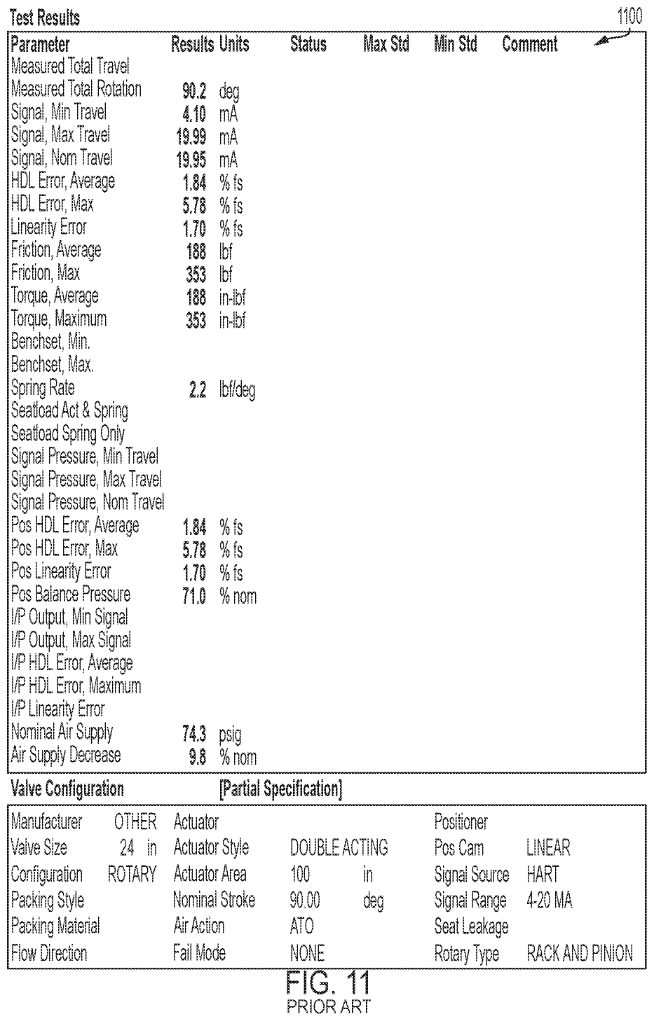

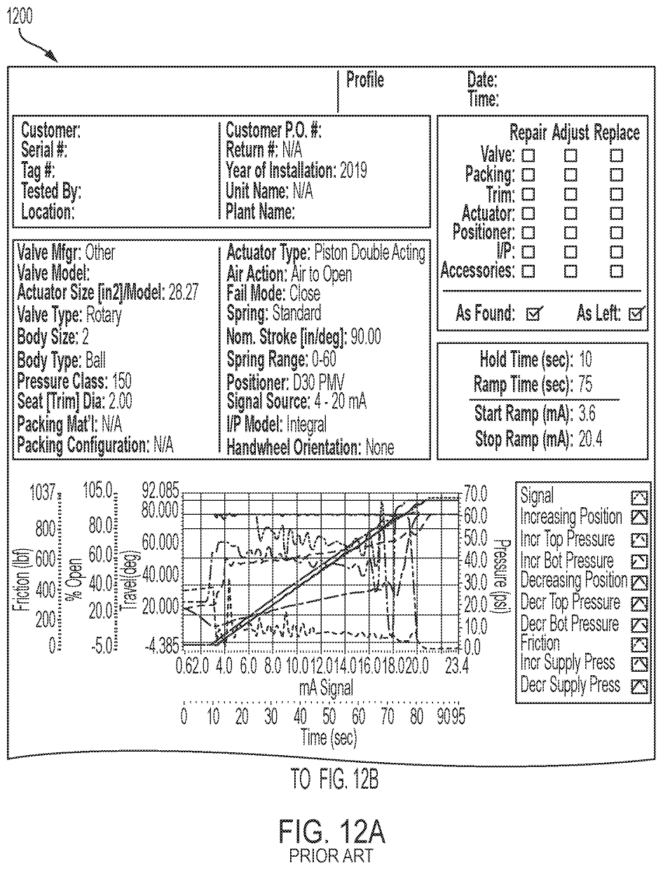

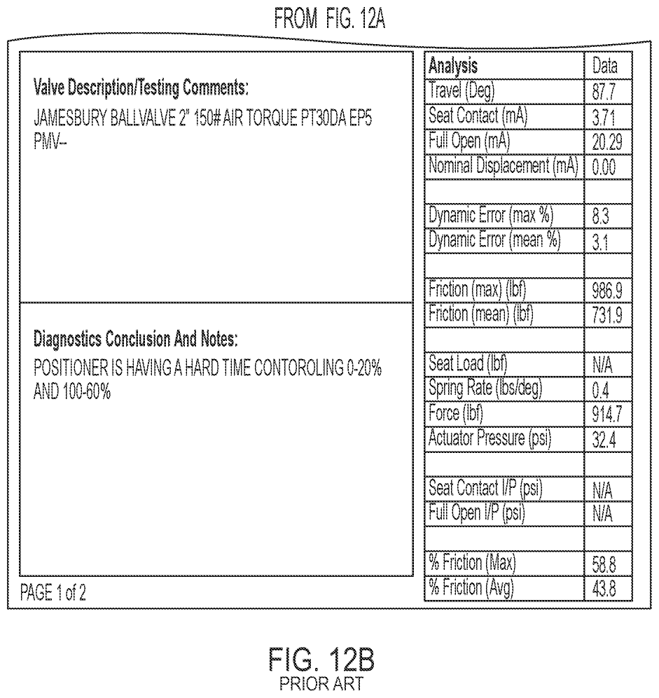

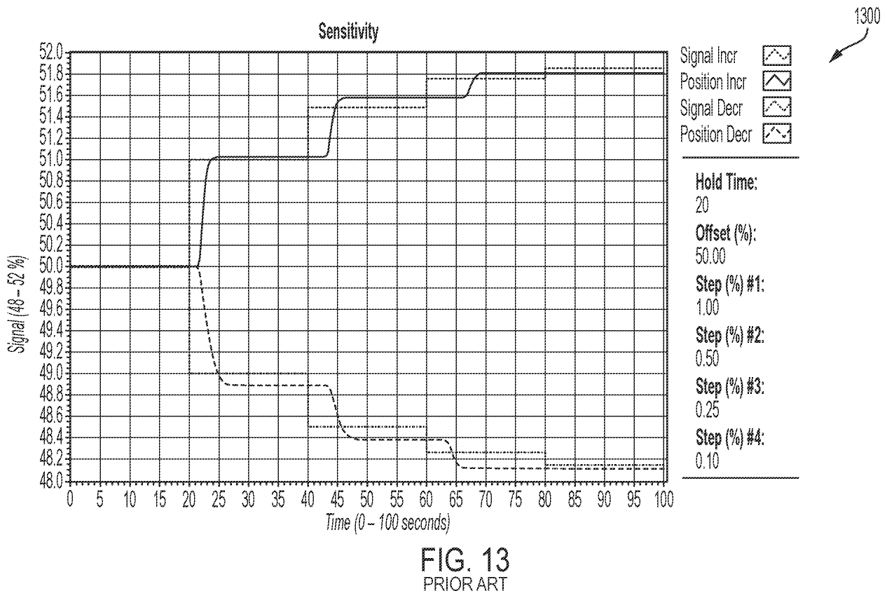

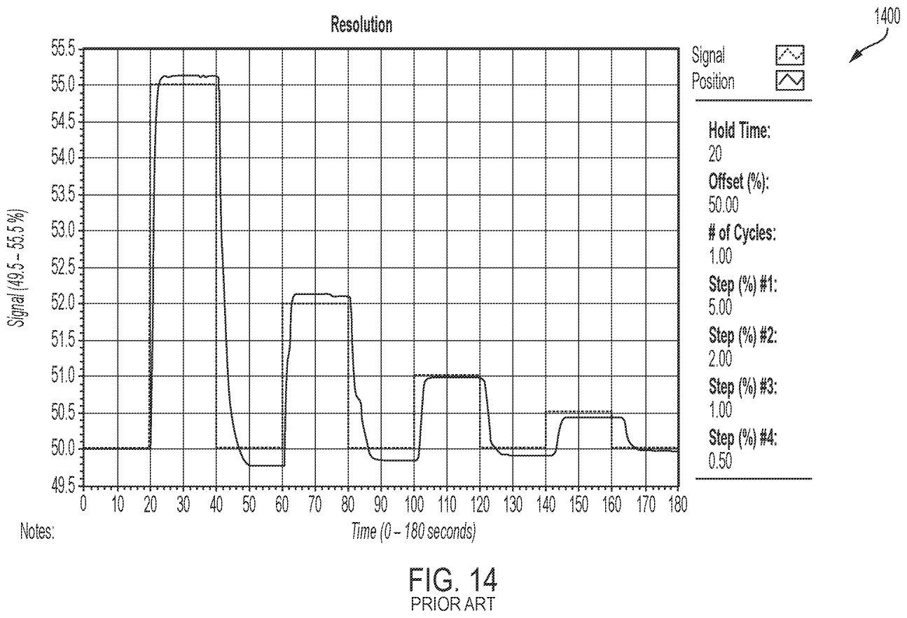

Unlike the examples illustrated in FIGS. 6-9, FIGS. 17-19 are examples of the reports and analytical insight available under the methods and processes of the current disclosure. Persons of skill in the art will appreciate that the examples in FIGS. 17-19 illustrate more than just data and values.

Turning now to FIG. 17, an example of a dynamic improvement path summary 1700 is illustrated. The dynamic approach may reduce the information a user needs to evaluate. The identified or detected issues may be listed first. Any issues that may be unable to be determined (e.g., indeterminate) given the listed valve settings may be marked as indeterminate. Issues may also be assigned an issue priority. Any selected or recommended improvement paths may be readily available and displayed to the user. In addition to presenting an improvement path summary that may be dynamic and not static, the improvement path summary also may allow for data reduction by only reporting what may be relevant and/or useful to the user.

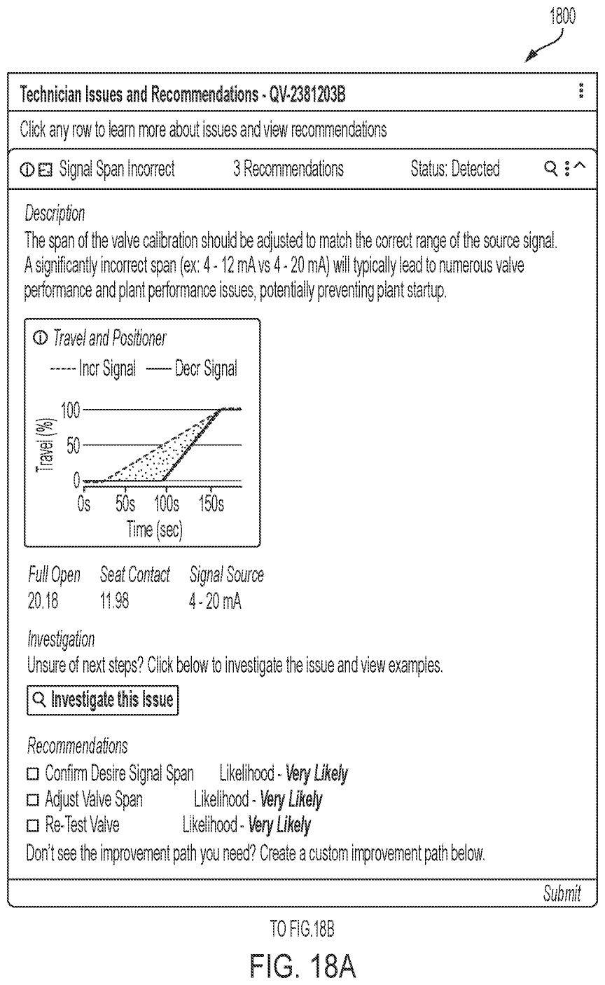

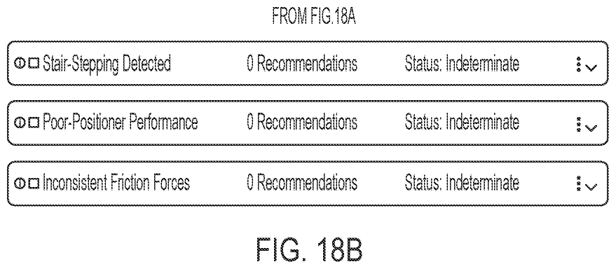

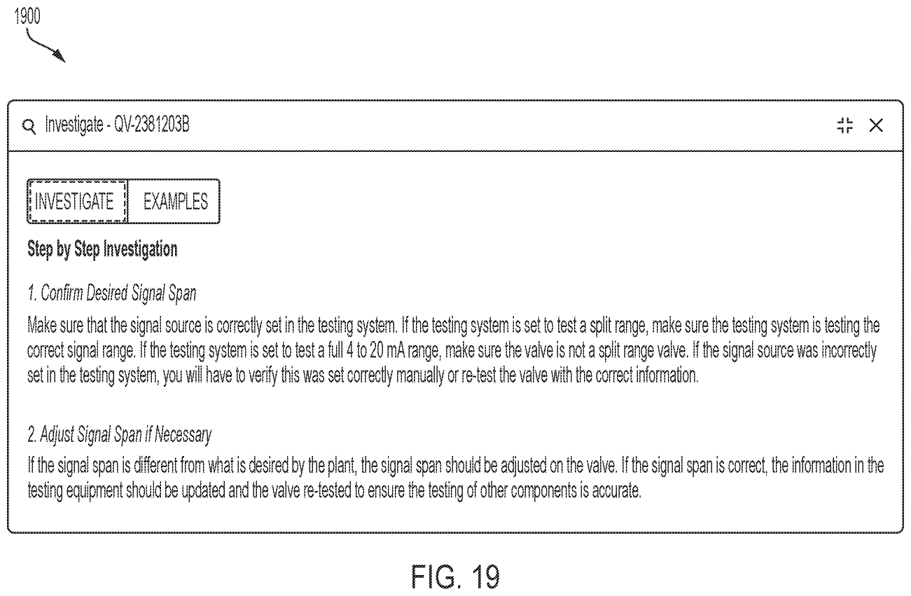

FIGS. 18A-B illustrate an example of an expanded dynamic improvement path summary 1800. The presentation of issues are simplified, in that the data the user may utilize to make a determination about the issue may be provided. For example, a first portion of graphical information associated with the issues may be displayed and a second portion of the graphical information associated with the issues may not be displayed, where the first portion of graphical information may be used to make a determination about the issue and the second portion of the graphical information may not be used to make a determination about the issue. Recommended investigation steps to confirm the issue and the proposed action items to resolve the issues are illustrated in FIG. 19. Lastly, recommended action items may be selectable, which may expand to include descriptions and other items that may be already filled out for the user. Input obtained from a user can be used to confirm the user viewed the report, evaluated the correctness of the report, and that the report is correct.

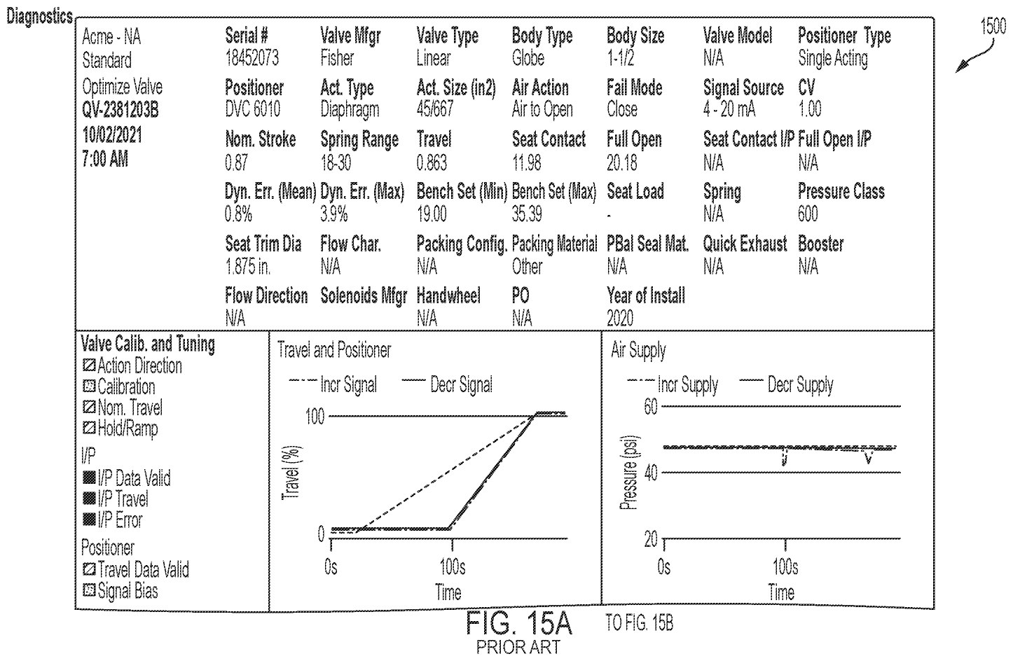

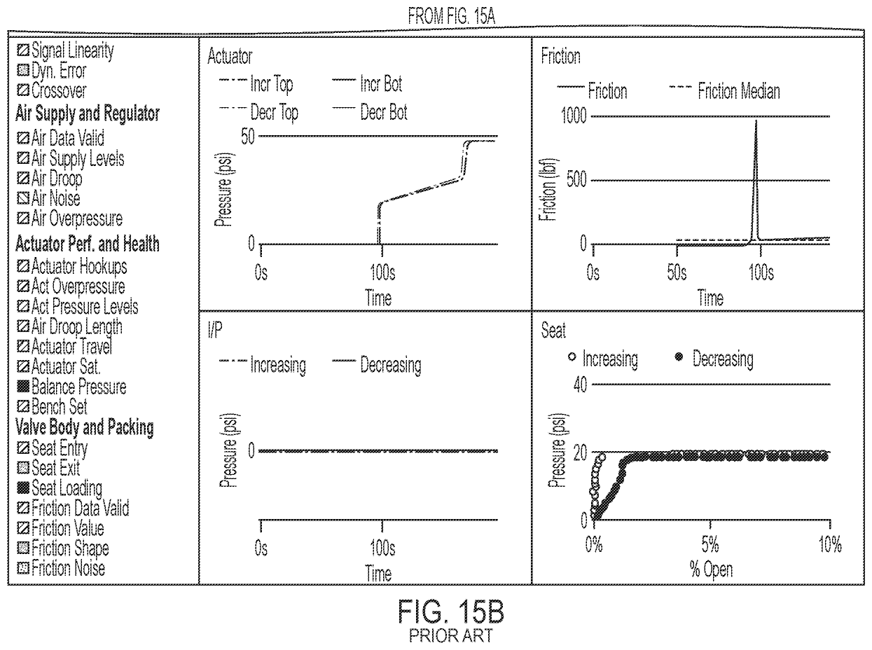

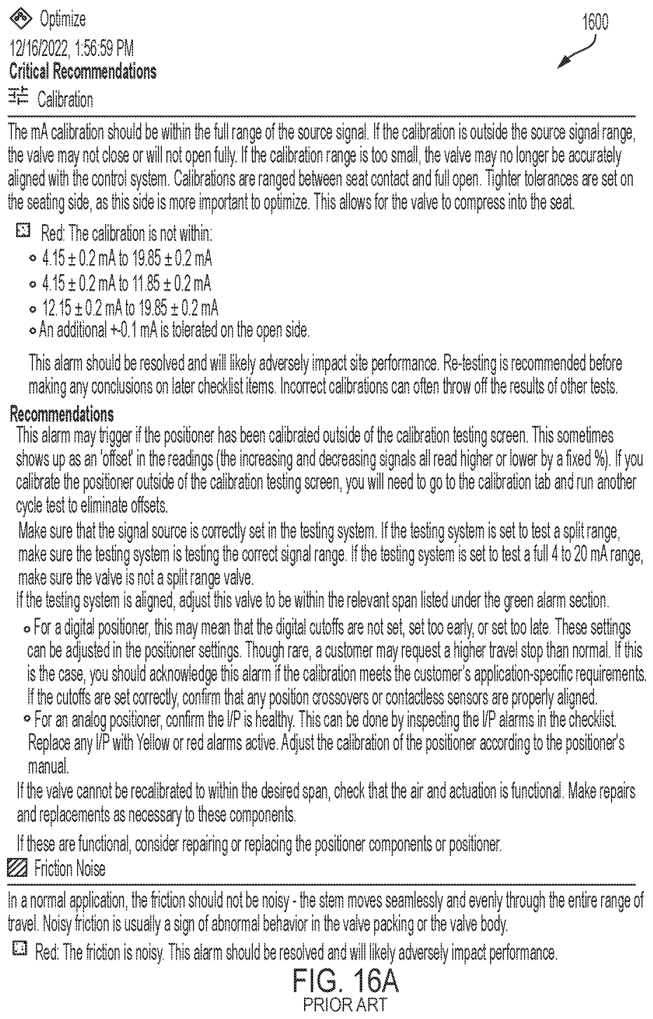

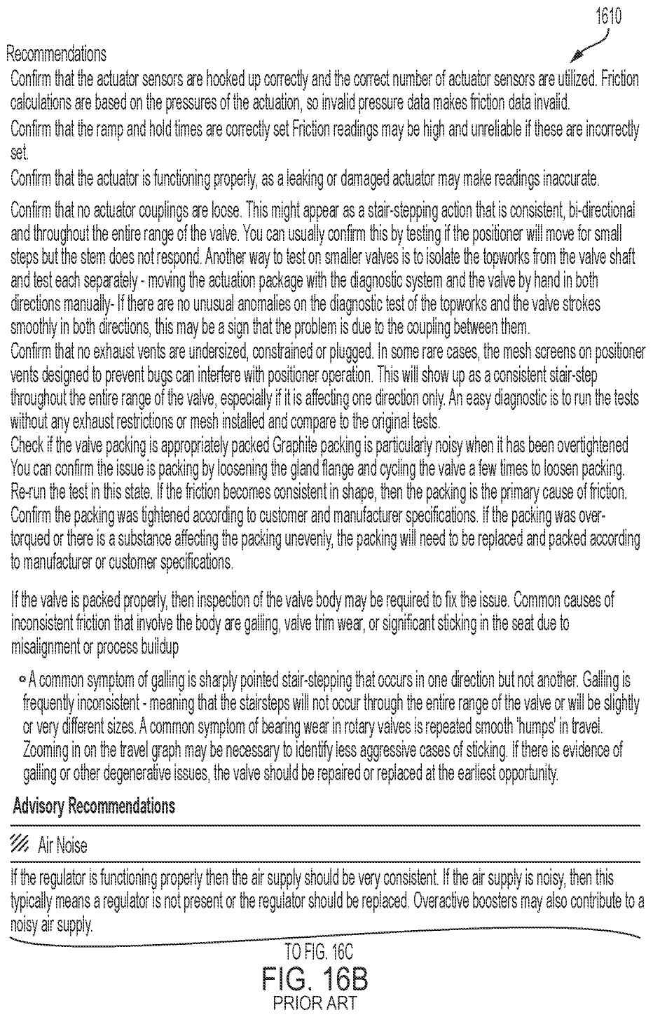

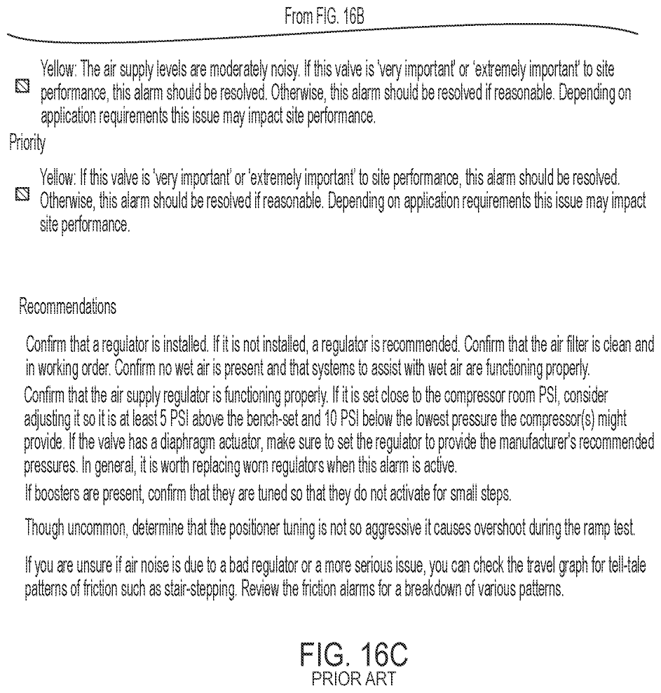

FIG. 19 illustrates an example of a dynamic improvement path investigation phase 1900. Compared to FIGS. 17-18, information may be displayed in paragraphs. Should the user find the recommended actions or information insufficient, relevant information may be provided to the user about the current state of the valve, such as shown in FIGS. 15-16. The user may be allowed to edit or suggest their own action items in conjunction, should they desire.

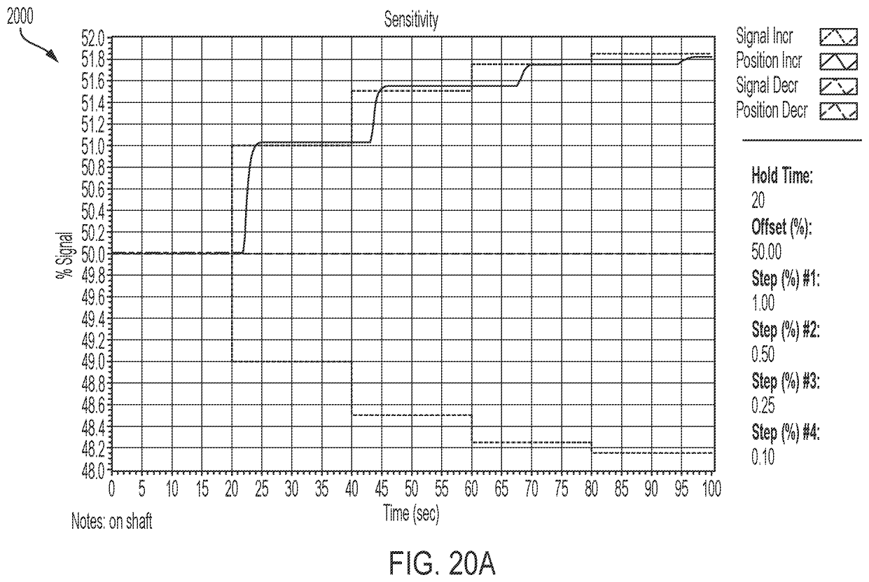

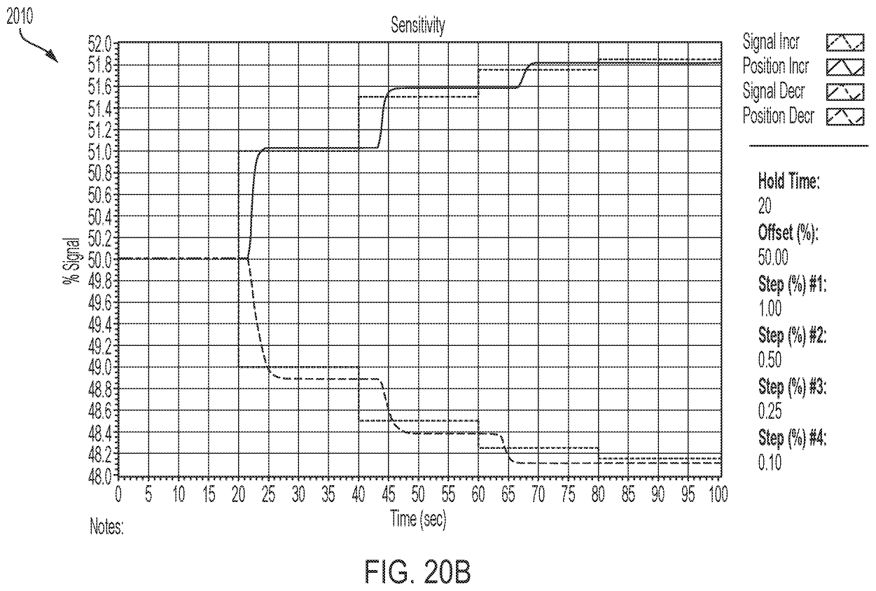

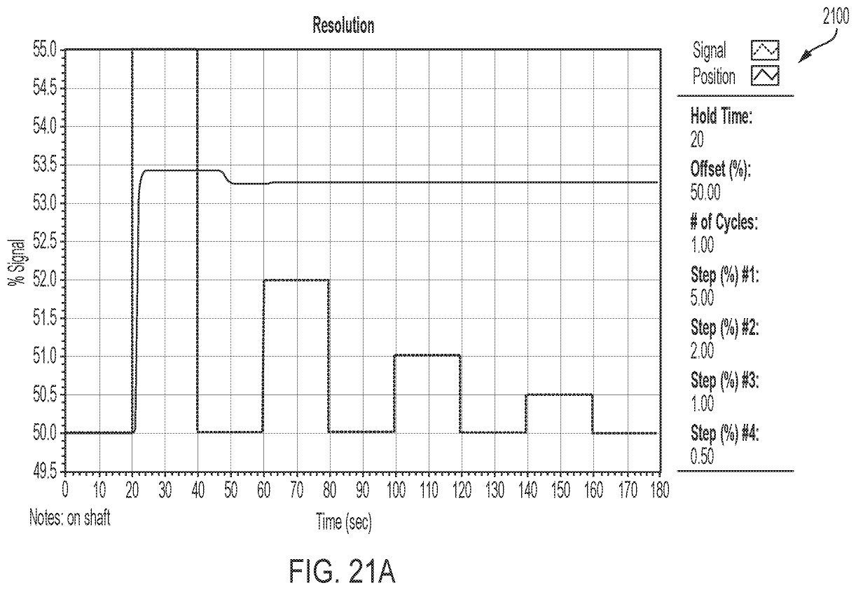

FIGS. 20A-B illustrate a comparison between an offline measurement at the bottom of the shaft measurement vs. a measurement at a positioner. The results depicted may be true in some instances as many valves may provide reliable data from the positioner. In some instances, a correlation between the shaft measurement vs. the measurement at the positioner may be obtained, which may contribute to improved accuracy and/or results of the valve testing, analysis, and/or recommended actions. The results illustrate a higher accuracy in the positioner than the shaft counterpart. The results illustrate an example performance from a valve that has loose couplings between the actuator and the rest of the valve body. FIG. 20A illustrates an output from measurement of the movement of the valve stem from the moment the valve stem exits the body 2000, while FIG. 20B illustrates an output from measurement of the movement of the valve as perceived by the digital positioner 2010. The examples in FIGS. 20A-B illustrate one of several instances where digital positioner measurement may give a false impression of valve performance. However, as loose couplings tend to be a stable issue, that knowledge may be reliably transferred from a test at the valve stem into analysis from a digital positioner test.

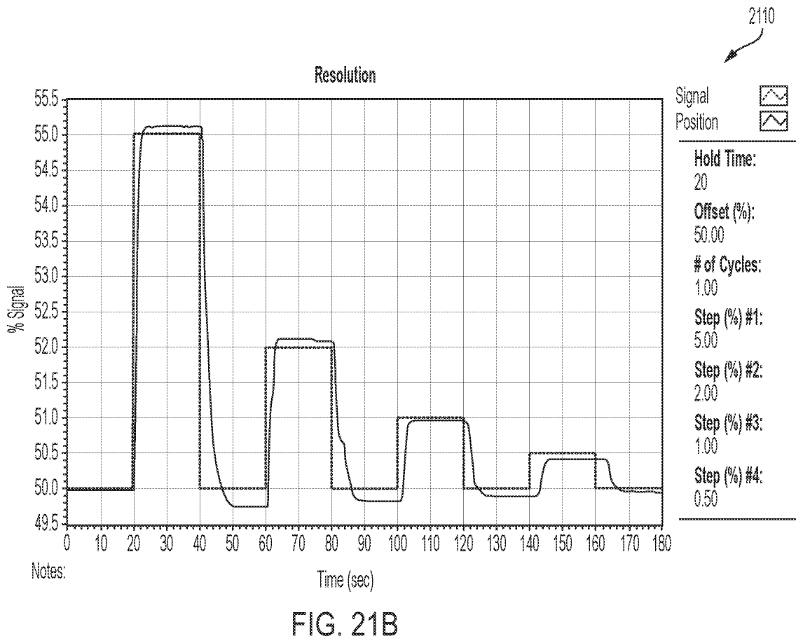

FIGS. 21A-B illustrate a comparison between an offline measurement at the bottom of the shaft measurement vs. a measurement at the positioner. Similar to FIGS. 20A-B, the results depicted may be true in some instances as many valves may provide reliable data from the positioner. The charts illustrate an example performance from a valve that has loose couplings between the actuator and the rest of the valve body. FIG. 21A illustrates an output from a measurement of the movement of a valve stem from the moment the valve exits the body 2100, while FIG. 21B illustrates an output from a measurement of the movement of the valve as perceived by the digital positioner 2110. The examples in FIG. 21A-B illustrate one of several instances where a digital positioner measurement may give a false impression of valve performance. However, as loose couplings tend to be a stable issue, that knowledge may be reliably transferred from a test at the valve stem into analysis from a digital positioner test.

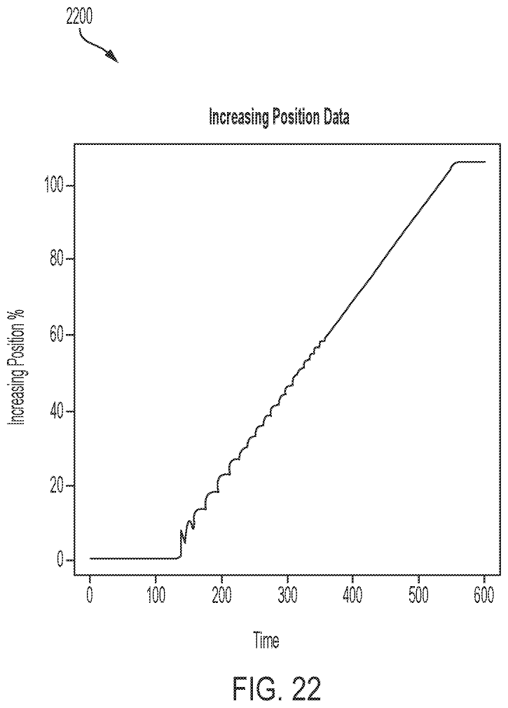

FIG. 22 illustrates raw data before normalization and analysis using a stair-stepping algorithm with increasing position data 2200. The plot of the stair-stepping algorithm shows increasing valve position data (as a percentage) from a valve with stair-stepping due to galling from 0 to 100% over time (illustrated as 0 to 60 seconds in tenths of seconds). As will be appreciated by those skilled in the art, the measurement data can be a percentage, an actual distance (e.g., in inches, mm, degrees), or can be unitless. Once the data in FIG. 22 is normalized in an effective manner, a number of approaches become viable for detecting stair-stepping under a number of circumstances.

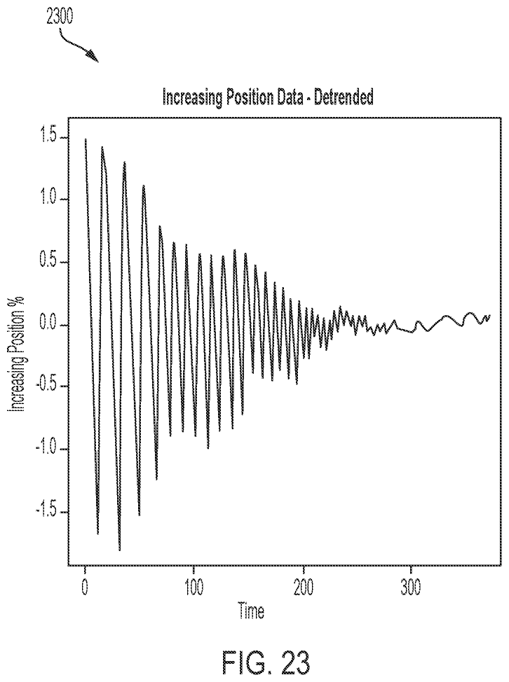

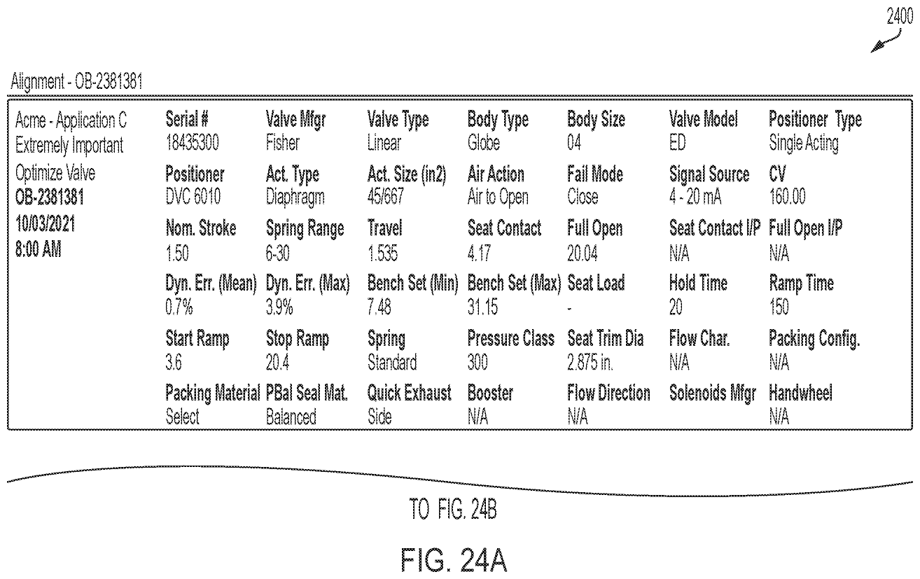

FIG. 23 is an example of effective normalization, where artifacts like non-linearity may be eliminated. In this state, it is viable to conduct an analysis of oscillatory behavior and/or an analysis of noise. Without the normalization phase, multiple artifacts may interfere with the analysis of data and/or may prevent a consistent and reliable approach to detection. The data in FIG. 23 illustrates an output of a detrended stair-stepping algorithm which is a plot of the normalized data that may be inspected for oscillations 2300. The data illustrates increasing position as a percentage from approximately −1.5% to 1.5% over time (e.g., from 0 to 300 seconds). The data can be normalized in all the graphs in the X axis too—thereby smoothing, extrapolating, etc., the data to standardize the data. So, for example the 600-point graph illustrated in FIG. 22 may be extrapolated from 600 points to 3000 points.

During an analysis phase, checks on the valves can be made that may be independent or interdependent (e.g., cross-correlation, cross-reference etc.). Cross-referencing can also be performed during the analysis phase, at a secondary stage or at the same time during a later stage. The analysis phase may be neutral to algorithms (e.g., AI, machine learning etc.). The stair-stepping algorithm may be implemented to include additional algorithms and methods for improving detection rates or eliminating type I (false positives) or type II (false negatives) errors. As an example, a test for a rare condition can have a high overall accuracy but still have limited diagnostic power if all of the errors are false positives.

The stair-stepping algorithm may be operable to utilize oscillation amplitude, duration, and/or locations. In some configurations, the stair-stepping algorithm may be operable to utilize additional algorithms and/or methods for eliminating root causes and/or determining which root causes may be more likely the cause of detected performance issues. Alternatively, or additionally, implementations can highlight when the stair-stepping was detected.

For cross-signature testing, the systems and methods may be operable to be neutral to which testing format may be used and/or the order of the testing thereof (e.g., offline test from method A vs. a positioner test from method B). Alternatively, or additionally, the cross-signature testing may be used to combine and/or compare results from current and/or past testing operations, which may add to results (e.g., an issue may be more likely to exist when multiple tests detect the issue or related issue), discount results (e.g., a discrepancy between results in two different tests may provide an indication of poor results or a non-issue), and/or otherwise contribute additional information to determinations made using the cross-signature testing. Implementations of the systems and methods may also be configured to place a time limit on how long certain checks may be considered ‘informative’ from prior tests. The time limit may reduce the likelihood that stale data may be incorporated into the analysis. Partial or no information may be provided if the valve specifications have changed between tests or for some testing formats (e.g., a partial ramp test vs. a full ramp test, increasing or decreasing, etc.). Implementations may also be configured to provide information based on ramp testing or on alternative tests (e.g., alternating step tests, same-step tests, etc.).

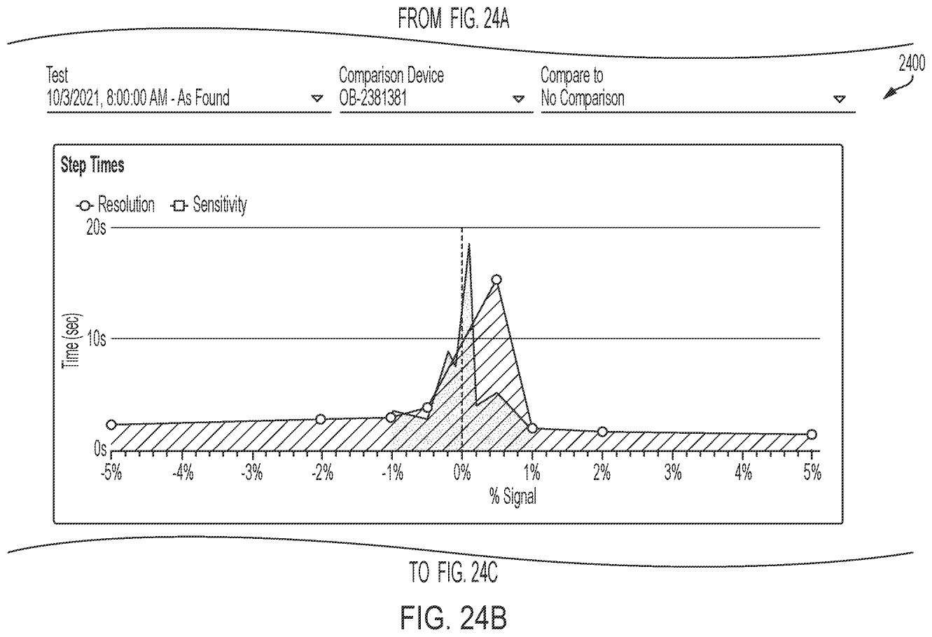

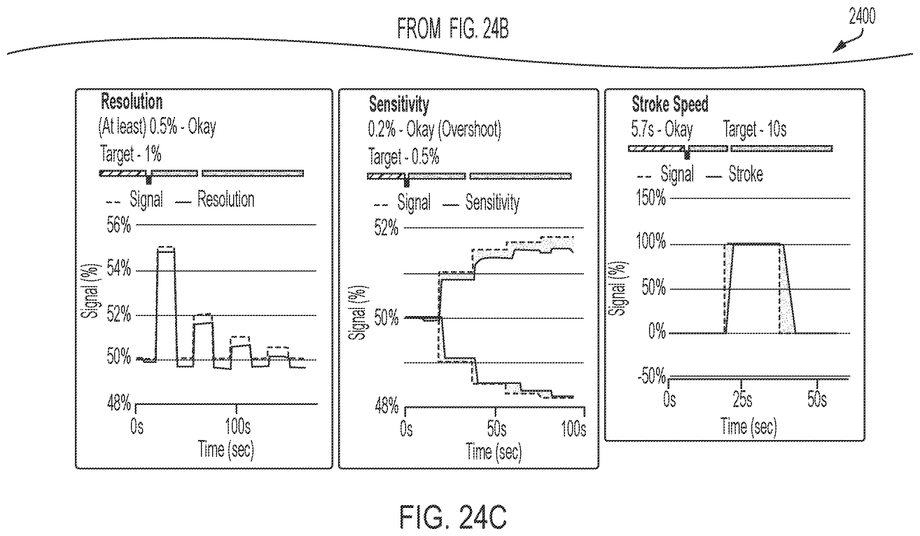

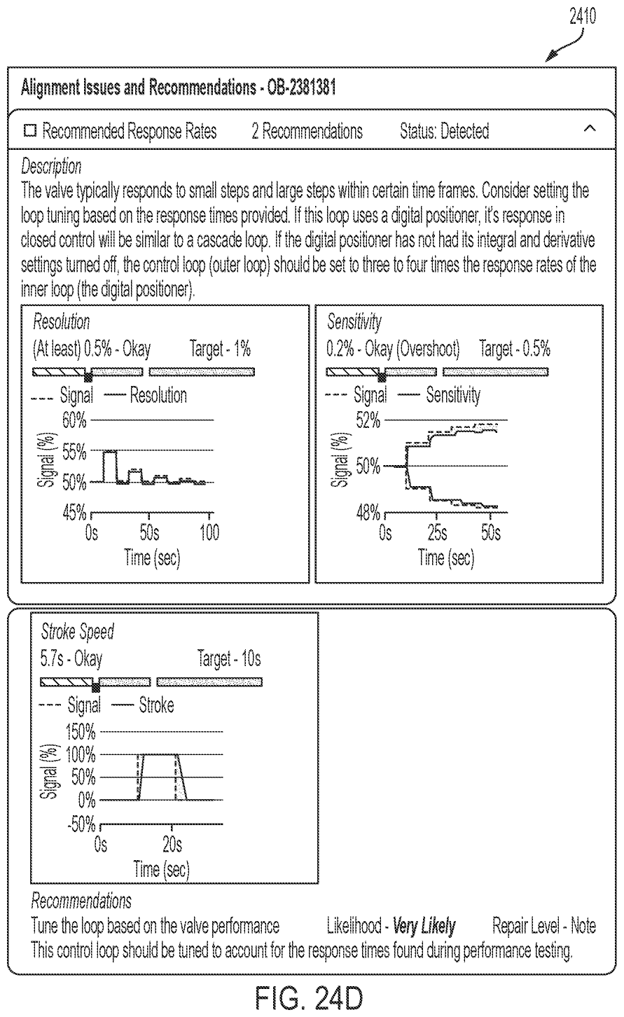

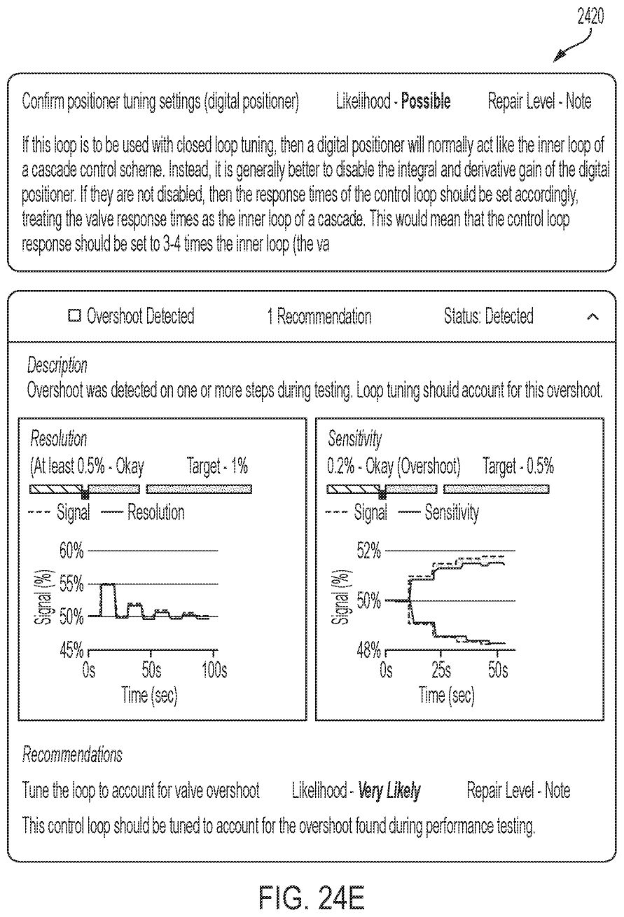

FIGS. 24A-E illustrate screenshots from a control system alignment module 2400, 2410, and 2420. The graphs and issues presented to the user in the interfaces depicted in FIGS. 24A-E may relate to what the control system needs to do given valve control, rather than the types of changes to the valve that are required. This process may allow for faster analysis, e.g., analysis can be achieved in seconds after a test is completed. Alternatively, or additionally, the identification of common and important valve issues may be easier. Consequently, more issues may be uncovered; issues may be uncovered faster; issues may be uncovered consistently without contributions of an expert; issues can be made clear to plant personnel so the plant personnel may not rely on a technician (with unknown skill level), and issues can be prioritized so plant time and energy may be spent on what is important to address, which can be critical with limited time and budgets.

In some implementations, the window to make changes to a valve may be limited (e.g., a facility turnaround). As noted above, knowing a valve may require invasive changes earlier can mean the difference between completing changes to the valve before the window closes or the valve being left in a deficient state for a significant period of time (sometimes years).

### III. Dynamic Determination

Automated and/or dynamic identification of valve performance and actionable steps to repair the valve may provide faster information and steps for resolution over the current manual analysis of valve testing.

In some instances, improving the valve may be insufficient to see real world results in terms of improved loop control. However, those responsible for improving the valve (e.g., a first entity) and those responsible for managing the control system (e.g., a second entity) may be different groups and/or different people. If the work regarding valve performance includes reporting to the control system group, then the total work required for optimal control loop performance may be more likely to be completed. For example, the first entity may perform improvements and/or repairs to the valve and surrounding systems, and/or may identify optimization operations associated with the valve, and the second entity may be operable to implement the identified optimization operations from the first entity. Alternatively, or additionally, the second entity may perform improvements and/or repairs to the valve and surrounding systems that may be independent of the operations performed by the first entity. The disclosed processes and systems may allow information to be processed real-time or near real-time to provide actionable information to multiple groups in an organization. Because the disclosed processes and systems capture the raw performance of the valve and how the valve performance relates to control performance, the jobs in an organization related to valve performance and control loop performance may be simplified. The simplification may be true given certain valves have settings that may include a more sensitive configuration than others.

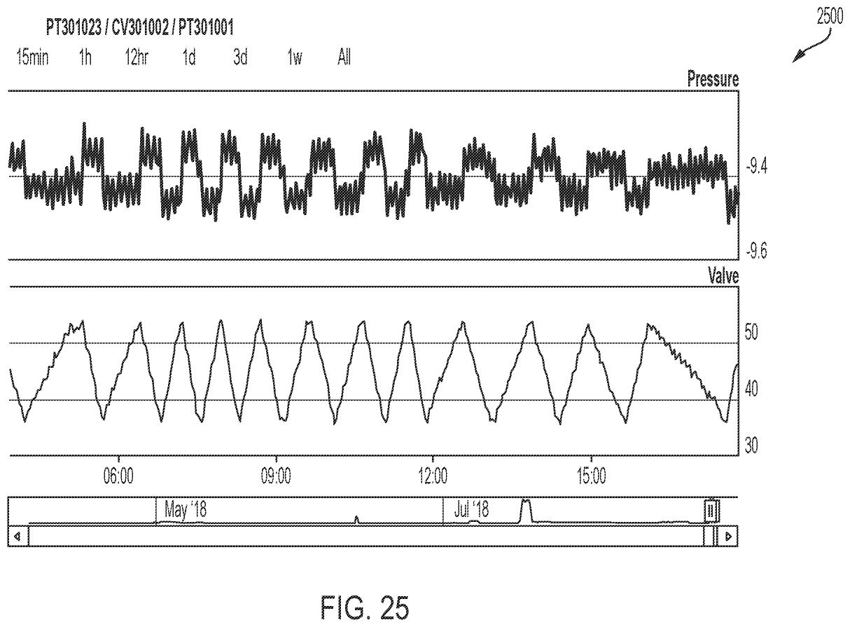

FIG. 25 illustrates an output from measurement of live monitoring data with a square tooth saw pattern 2500. FIG. 25 includes an illustration of a common live monitoring data pattern, where the valve may have “stiction” (one cause being galling). Detection of this pattern and/or a transmutation of this data may be used in plants to detect potential galling issues in live monitoring. However, there may be limitations - as noted above, as this is not a full range check, stiction may be detectable in certain ranges. If those ranges are not part of the active process range, then they may not be detected.

FIGS. 26A-B illustrates an example of HART Diagnostic outputs 2600, 2610. The example of HART Diagnostic outputs may be provided from a digital positioner. Note the alarms may describe a function and what may be happening and may not describe performance and/or why something may be happening.

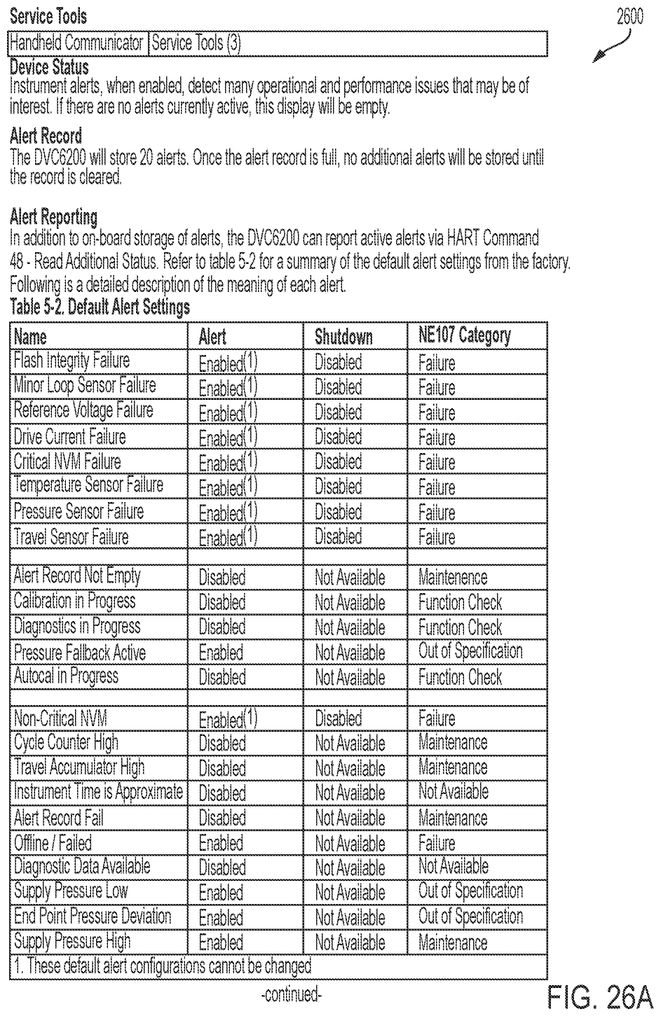

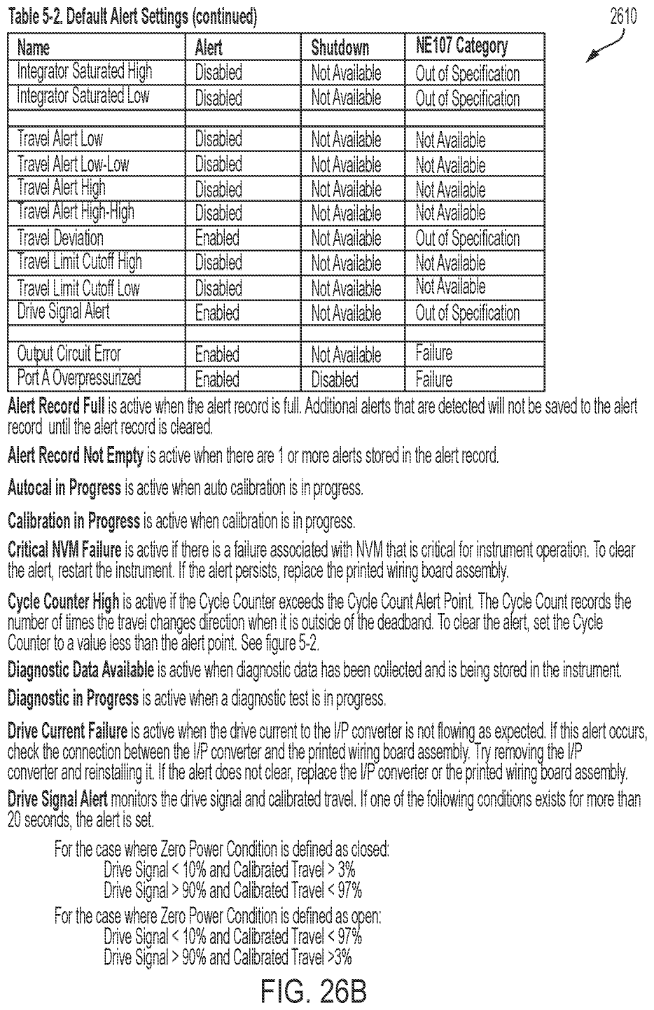

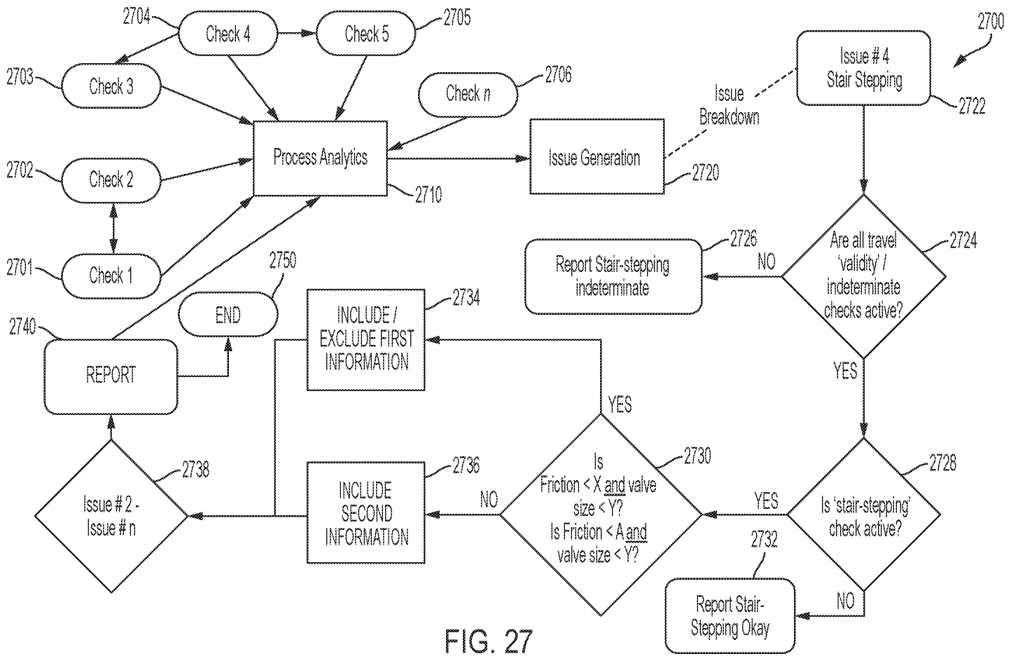

FIG. 27 illustrates a process 2700 that includes applying dynamic improvement path summaries and the results of detecting that the valve has low accuracy due to a coupling issue. At a later date, a valve signature may be obtained using a digital positioner approach and the results from earlier runs may be compared to results from later runs. The process 2700 may begin with a process analytics 2710 block. The process analytics 2710 block may receive data from multiple checks, e.g., check 1 2701, check 2 2702, check 3 2703, check 4 2704, check 5 2705, and/or check n 2706. The obtained data from the multiple checks may additionally be shared between one or more check systems either uni-directionally, or bi-directionally (e.g., check 4 2704 may share information uni-directionally with check 3 2703 and check 5 2705; and check 1 2701 may share data bi-directionally with check 2 2702). For example, checks performed at different times and/or producing different results may be shared between one another and/or with the process analytics 2710 such that any potentially relevant information obtained (including adequacy of sensors performing the checks) as part of the checks may be considered in view of each other to determine potential issues. Following the process analytics 2710, an issue generation 2720 may occur. An issue breakdown can be illustrated, e.g., issue 4, stair-stepping 2722. Once the issue breakdown occurs, the system may determine if all travel checks are active 2724. If all travel validity is not active 2724 (NO), then the system may report that stair-stepping may be indeterminate 2726. If all travel validity is active 2724 (YES), then the system may determine if the stair-stepping check is active 2728. If the system determines the stair-stepping check is not active 2728 (NO), then the system may report that stair-stepping may be okay 2732. If the stair-stepping check is active 2728 (YES), then the system may determine if friction is less than X and a valve size is less than Y and/or if friction is less than A and the valve size is less Y 2730. If the friction is less than X and the valve size is less than Y and/or if the friction is less than A and the valve size is less than Y 2730 (YES), then the system may include/exclude first information 2734. In this example, the first information may be one or more of: include a friction graph, include investigations for low-friction causes (e.g., a plugged vent), exclude investigations for high-friction causes (e.g., packing friction), include recommended actions for low-friction causes having a high likelihood, and/or exclude recommended actions for high-friction causes having a low likelihood for additional causes. If the friction is not less than X and the valve size is not less than Y and/or the friction is not less than A and the valve size not less than Y 2730 (NO), then the system may include second information 2736. In this example, the second information may be one or more of: include investigations for low-friction causes with low ordering, and include recommended actions for low-friction causes with very low likelihood. As will be appreciated by those skilled in the art, each example could vary so, for example, a different issue could include or exclude different graphs, different investigations, different recommendations, and adjust the likelihood of recommendations.

Following the step of either including/excluding the first information 2734 or including second information 2736, the system may proceed to process issue 2 through issue n 2738. Following the processing of the additional issues, a report may be generated 2740. The stair-stepping issue report may include a priority of issue, one or more graphs illustrating data output, additional diagnostic information, ordered active investigation steps, inactive investigations steps (which may be optional), active recommended improvements and the likelihood of positive impact (which can be ordered), inactive recommended improvements (e.g., improvements that may have been eliminated), and/or diagnostic helpers (e.g., descriptions, examples, etc.). Following the report, the process 2700 either ends 2750 or another cycle can start with the process analytics 2710. Performing another cycle can occur after one or more investigation steps and/or improvements have been made.

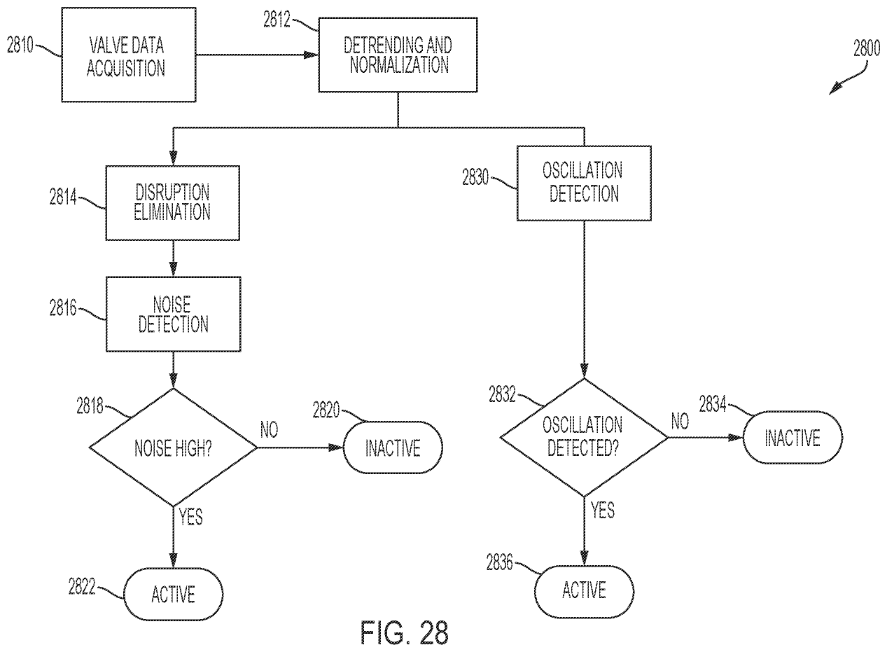

FIG. 28 is a flow chart of a stair-stepping algorithm 2800. The stair-stepping algorithm 2800 may begin with valve data acquisition 2810. Once the valve data is acquired, the data may be detrended and normalized 2812. Following the detrended and normalized 2812 in a normalization step, the output may be provided to a disruption and elimination process 2814. Following the disruption and elimination process 2814, the data may be analyzed to determine if noise is detected 2816. Any noise detected may be evaluated to determine if the noise level is high 2818. If the noise level is not high 2818 (NO), then the valve may be inactive 2820. If the noise level is high (YES), then the valve is active 2822. The noise may be determined to be high (or not high) relative to a threshold amount of noise, which may be input by a user and/or may be individually associated with a valve. In parallel to the disruption and elimination process 2814, the data may be analyzed for oscillation detection 2830 to determine if oscillation is detected 2832. If oscillation is not detected 2832 (NO), then the valve may be inactive 2834. If oscillation is detected 2832 (YES), then the valve may be active 2836. As will be appreciated by those skilled in the art, there are many potential implementations for the stair-stepping algorithm and changes could be employed without departing from the scope of the disclosure.

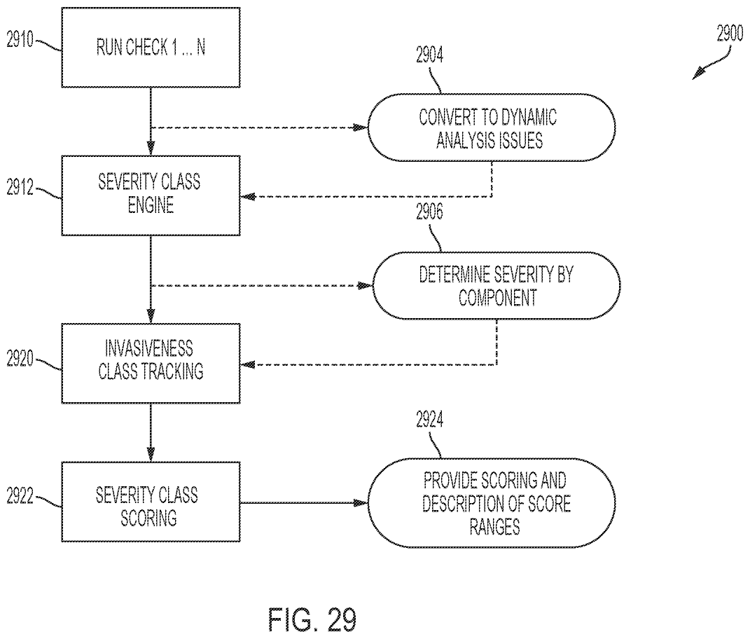

FIG. 29 is a flowchart of a function scoring algorithm 2900. The function scoring algorithm 2900 begins with performing one or more checks 2910 (e.g., run check 1 through check n). Once the checks 2910 are run, the data can optionally be converted to one or more dynamic analysis issues 2904 and checked for an indeterminate status. Following the checks 2910, or the optional conversion step, the data may be processed through a severity class engine 2912. The severity class engine 2912 may determine whether the valve is okay, requires field adjustment, requires valve repair, etc. Following processing by the severity class engine 2912, the data may optionally be analyzed to determine the severity of issues for a component and/or a likelihood of severity of a component during the severity determination step 2906. Following processing by the severity class engine 2912, or the optional severity determination step 2906, the data may be evaluated to determine invasiveness class tracking 2920. Invasiveness class tracking 2920 identifies, for example, how many of each class of issue may be present, and can further organize the class of issue by component. Following invasiveness class tracking 2920, the severity of the class is scored 2922, and the scoring may be provided to the user 2924. In addition to providing the scoring to the user 2924, score ranges and/or descriptions of the score ranges may also be provided. The scoring, as determined by the function scoring algorithm 2900, may contribute to the user determining to further analyze and/or correct issues with a particular valve of multiple valves, in view of potentially limited resources (e.g., time, money, manpower, window of opportunity, etc.) and/or in view an amount of invasiveness any actions associated with the particular valve may include. For example, the function scoring algorithm 2900 may generate scores that may be associated with a valve, and the scores associated with the valve may contribute to determining at least an importance of the valve to operations (e.g., such as site operations), an importance of operations performed by the valve to site operations, performance metrics associated with the valve and/or associated components, performance targets associated with the valve and/or associated components, etc. As will be appreciated by those skilled in the art, there are many potential implementations for the function scoring algorithm 2900 and changes could be employed without departing from the scope of the disclosure.

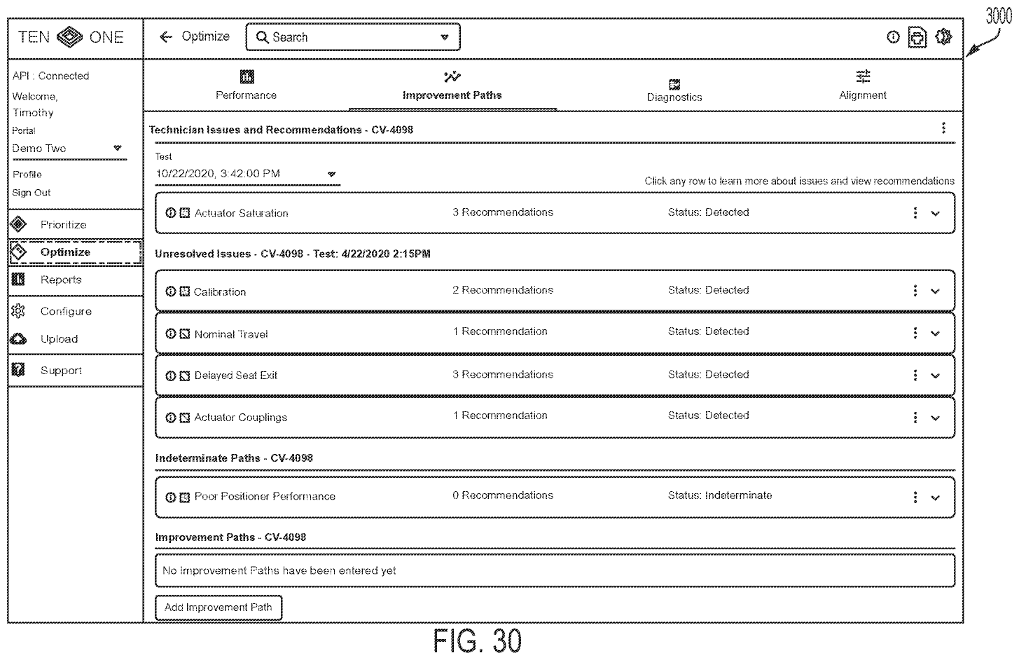

FIG. 30 illustrates a graphical user interface 3000 of an output following application of the processes described herein. By providing cross-test data, significantly more information may be provided than instances in which relevant historical data is ignored. For example, data obtained at different times and/or using different tests (or in other words, cross-test data) may be considered in the information to generate the output as illustrated. In the illustrated example in the graphical user interface 3000, the calibration of the valve and nominal travel may not have been properly set, and that may impact the frame of reference for the 10/22 test data. Alternatively, or additionally, loose actuator couplings may invalidate the ability to properly test positioner performance and accuracy from certain testing methods. Including this additional information in the analysis may avoid falsely reporting that the obtained data may be high performing, and can instead report that some information may not be determined or that certain results may be misleading/poor performing.

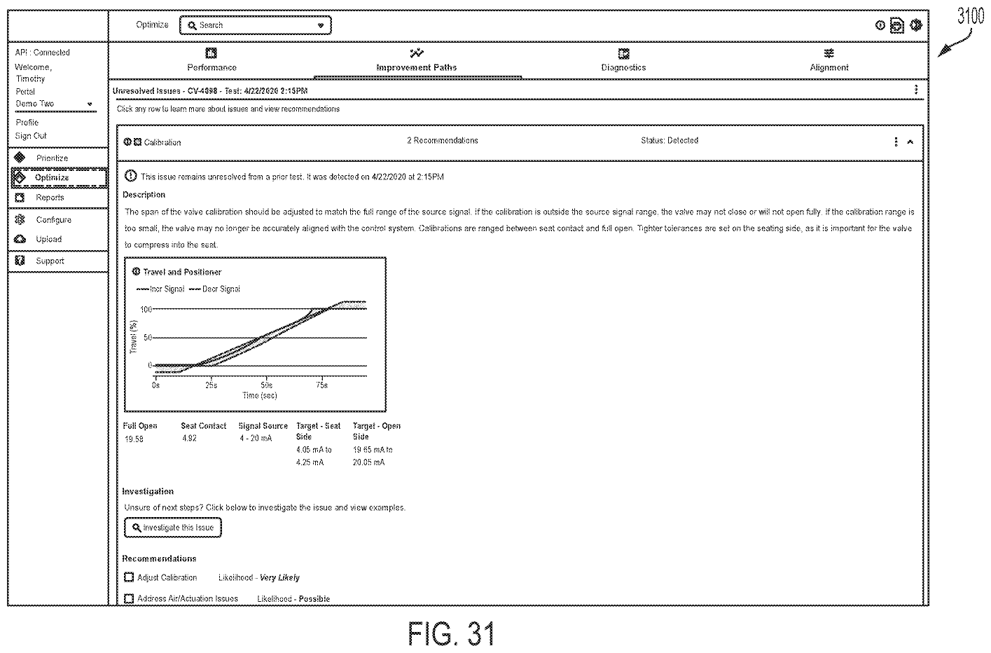

FIG. 31 illustrates an output showing improvement path summaries with cross-test data 3100. One implementation may provide the user with information about the source of the additional information. By knowing the source of the data, the user can make determinations to see if the system may be providing an accurate analysis.

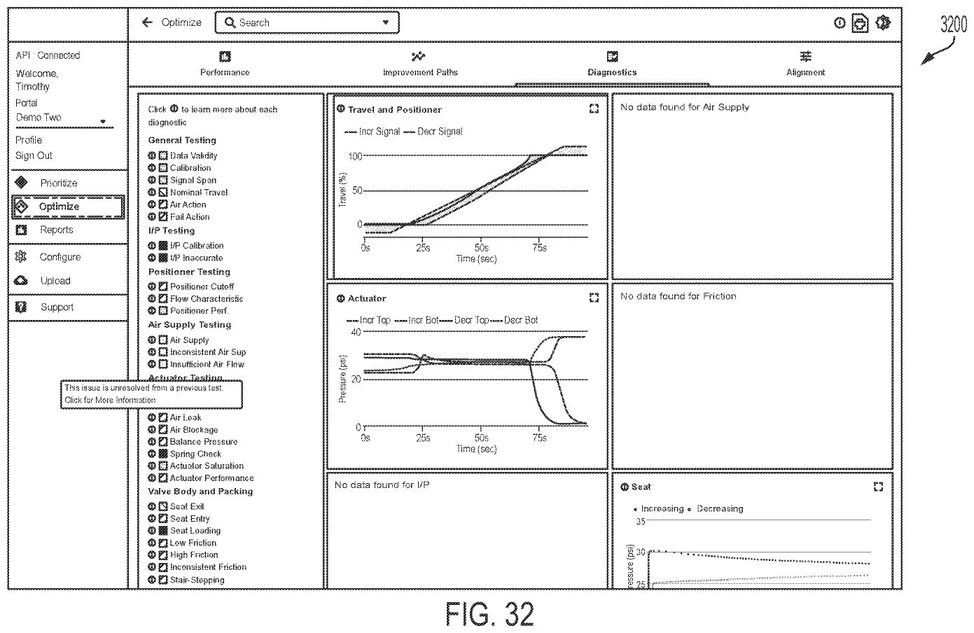

FIG. 32 illustrates a static analysis with cross-test data 3200. In other implementations, cross-test analysis may be performed using other methodologies, such as static analysis or even without additional insights or information provided. These implementations may choose to highlight or not highlight how the additional information may be handled. In this case, the air supply alarms may be highlighted in blue to denote they were acceptable from a previous test.

In some configurations, high-accuracy data collection may not be required. As will be appreciated by those skilled in the art, there are universes where a test run with incomplete and/or poor sensors may be compared to a historical test that was run with complete or high accuracy sensors and information about right actions may be updated based on the combination (like GPS systems−dead reckoning+satellite=more accurate than either).

### Computing and Network Environments

As will be appreciated by those skilled in the art, data transmission from the devices can be wired and communicated to a distributed control system (DCS), a programmable logic controller (PLC), or a supervisory control and data acquisition system (SCADA) with historical data to that DCS/PLC/SCADA stored in a historian. A common approach is to extract data from the historian or a similar data repository. Data extraction can be, for example, via a direct connection or an export (e.g., a comma separated value (CSV) or Excel (or other spreadsheet) file (XLS). Additionally, there may be relevant data in other locations such as enterprise resource planning (ERP) systems like SAP ERP (developed by SAP®) which may be supplied to and evaluated in the disclosed processes.

The wired and/or wireless communication methods of the devices to the distributed control system(s) can be, for example, Highway Addressable Remote Transducer (HART) bi-directional communication protocol for transferring multiple signals by superimposing low-level digital signals on the, 4-20 mA signal used for standard analog signal transmission, Foundation Fieldbus protocol, Process Field Bus (PROFIBUS), etc. A direct connection to devices is also possible with no distributed control system in between.

Many example implementations have been described in part in the above sections of this disclosure. The system operates on computer systems that can be a combination of on-premises, in the cloud (hosted externally), mobile devices, IoT sensors attached to equipment stationary or mobile such as to UAV (Unmanned Aerial Vehicles or drones) and an extensible set of third party supplied applications and devices that extend the functionality of the system. Distributed network architecture ensures network stability, redundancy and resilience built into the network. A distributed computing network built using the distributed network architecture described above can run distributed applications, for example, autonomous distributed building or device control systems, web services, secure peer to peer networking, distributed data management services, cloud storage, distributed databases, decentralized groups or companies, blockchain based distributed trading platforms, cryptographic tokens, document processing, blockchain based Turing complete virtual machines, graphics rendering, distributed blockchain based accounting systems, etc.

Multiple computing devices can be deployed in implementing the disclosed systems and methods. Computing devices include one or more: computing device processors, memories, storage devices, high-speed interfaces connecting to memory and high-speed expansion ports, and low speed interfaces connecting to low speed bus and storage device. Each of the components of the one or more computing devices can also be interconnected using various busses, and can be mounted on a common motherboard or in other manners as appropriate. Processor can process instructions for execution within computing device, including instructions stored in memory or on storage device to display graphical data for a GUI on an external input/output device, including, e.g., each computing device can include a display coupled to high speed interface. In other implementations, multiple processors and/or multiple busses can be used, as appropriate, along with multiple memories and types of memory. Also, multiple computing devices can be connected, with each device providing portions of the operations (e.g., as a server bank, a group of blade servers, or a multi-processor system).

Memories are configurable and operable to store data within computing devices. In one implementation, memory is a volatile memory unit or units. In another implementation, memory is a non-volatile memory unit or units. Memory can also be another form of computer-readable medium (e.g., a magnetic disk, optical disk or solid state disk). Memory can also be non-transitory.

Storage devices are capable of providing mass storage for computing device. In one implementation, storage device can be or contain a computer-readable medium (e.g., a floppy disk device, a hard disk device, an optical disk device, or a tape device, a flash memory or other similar solid state memory device, or an array of devices, such as devices in a storage area network or other configurations). A computer program product can be tangibly embodied in a data carrier. The computer program product also can contain instructions that, when executed, perform one or more methods (e.g., those described above.) The data carrier is a computer- or machine-readable medium, (e.g., memory, storage device, memory on processor, and the like).

High-speed controllers manage bandwidth-intensive operations for computing device, while low speed controllers manage lower bandwidth-intensive operations. Such allocation of functions is an example only. In one implementation, high-speed controller is coupled to memory, display (e.g., through a graphics processor or accelerator), and to high-speed expansion ports, which can accept various expansion cards. In the implementation, low-speed controllers are coupled to storage devices and low-speed expansion port. The low-speed expansion port, which can include various communication ports (e.g., USB, Bluetooth®, Ethernet, wireless Ethernet), can be coupled to one or more input/output devices (e.g., a keyboard, a pointing device, a scanner, or a networking device including a switch or router, e.g., through a network adapter). Computing devices can be implemented in a number of different forms, as shown in the figure. For example, computing devices can be implemented as standard server, or multiple times in a group of such servers. Computing devices can be implemented as part of rack server system. In addition or as an alternative, it can be implemented in a personal computer (e.g., laptop computer). In some examples, components from computing devices can be combined with other components in a mobile device (not shown), e.g., device. Each of such devices can contain one or more of computing devices and an entire system can be made up of multiple computing devices communicating with each other.

Computing device includes processor, memory, an input/output device (e.g., display, communication interface, and transceiver) among other components. Device also can be provided with a storage device, (e.g., a microdrive or other device) to provide additional storage. Each of the devices, processor, display, memory, communication interfaces, and transceiver, are interconnected using various buses, and several of the components can be mounted on a common motherboard or in other manners as appropriate.

A processor can execute instructions within computing device, including instructions stored in memory. The processor can be implemented as a chipset of chips that include separate and multiple analog and digital processors. The processor can provide, for example, for coordination of the other components of device, e.g., control of user interfaces, applications run by device, and wireless communication by device.

Processor can communicate with a user through control interface and display interface coupled to display. Display can be, for example, a TFT LCD (Thin-Film-Transistor Liquid Crystal Display) or an OLED (Organic Light Emitting Diode) display, or other appropriate display technology. Display interface can comprise appropriate circuitry for driving display to present graphical and other data to a user. Control interface can receive commands from a user and convert them for submission to processor. In addition, external interface can communicate with processor, so as to enable near area communication of device with other devices. External interface can provide, for example, for wired communication in some implementations, or for wireless communication in other implementations, and multiple interfaces also can be used.

Memory stores data within computing device. Memory can be implemented as one or more of a computer-readable medium or media, a volatile memory unit or units, or a non-volatile memory unit or units. Expansion memory also can be provided and connected to device through expansion interface, which can include, for example, a SIMM (Single In Line Memory Module) card interface. Such expansion memory can provide extra storage space for device, or also can store applications or other data for device. Specifically, expansion memory can include instructions to carry out or supplement the processes described above, and can include secure data also. Thus, for example, expansion memory can be provided as a security module for device, and can be programmed with instructions that permit secure use of device. In addition, secure applications can be provided through the SIMM cards, along with additional data, (e.g., placing identifying data on the SIMM card in a non-hackable manner).

The memory can include, for example, flash memory and/or NVRAM memory, as discussed below. In one implementation, a computer program product is tangibly embodied in a data carrier. The computer program product contains instructions that, when executed, perform one or more methods, e.g., those described above. The data carrier is a computer- or machine-readable medium (e.g., memory, expansion memory, and/or memory on processor), which can be received, for example, over transceiver or external interface.

Device can communicate wirelessly through communication interface, which can include digital signal processing circuitry where necessary. Communication interface can provide for communications under various modes or protocols (e.g., GSM voice calls, SMS, EMS, or MMS messaging, CDMA, TDMA, PDC, LTE, WCDMA, CDMA2000, or GPRS, among others or any newly developed communication protocols) Such communication can occur, for example, through radio-frequency transceiver. In addition, short-range communication can occur, e.g., using a Bluetooth®, WiFi, or other such transceiver (not shown). In addition, GPS (Global Positioning System) receiver module can provide additional navigation- and location-related wireless data to device, which can be used as appropriate by applications running on a device. Sensors and modules such as cameras, microphones, compasses, accelerators (for orientation sensing), etc. may be included in the device. It will be appreciated by those skilled in the art, that the devices and systems described can communicate using many of the common and emerging internet-of-things (IoT) protocols depending on the situation and the environment. Examples of protocols include Zigbee, LoRa (wide area long range protocol), NB-IoT (narrow band IoT), WiFi, BLE (blue tooth low energy).

Device also can communicate audibly using audio codec, which can receive spoken data from a user and convert it to usable digital data. Audio codec can likewise generate audible sound for a user, (e.g., through a speaker in a handset of device). Such sound can include sound from voice telephone calls, can include recorded sound (e.g., voice messages, music files, and the like) and also can include sound generated by applications operating on device.

Computing device can be implemented in a number of different forms, as shown in the figure. For example, it can be implemented as cellular telephone. It also can be implemented as part of smartphone, tablet, a personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor. The programmable processor can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. The programs can use one or more algorithms. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a device for displaying data to the user (e.g., a CRT (cathode ray tube) or LCD (liquid crystal display) monitor), and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a backend component (e.g., as a data server), or that includes a middleware component (e.g., an application server), or that includes a frontend component (e.g., a client computer having a user interface or a Web browser through which a user can interact with an implementation of the systems and techniques described here), or a combination of such back end, middleware, or frontend components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures. Components of the system can be distributed by short, medium, and long distances depending on the location of the target under measurement. In some configurations the devices, such as measurement devices, operate asynchronously and capture data locally and then transit/retransmit when a signal is detected.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that any claims presented define the scope of the invention and that methods and structures within the scope of these claims and their equivalents be covered thereby.

What is claimed is:

1. A method comprising:
obtaining, using one or more sensors associated with a control valve, data associated with the control valve;
performing an analysis corresponding to the control valve using at least the data obtained; and
generating a report using the analysis, the report including information associated with the control valve.

2. The method of claim 1, further comprising obtaining an input from a user to confirm the user viewed the report and a correctness of the report.

3. The method of claim 1, further comprising implementing an improvement path detailed in the report to repair the control valve and not repair a second control valve of a plurality of control valves, wherein the improvement path includes a first score associated with the control valve and a second score associated with the second control valve, and the first score indicates a greater likelihood of issue than the second score.

4. The method of claim 1, wherein the one or more sensors are traceable-calibration sensors that are located in one or more of the control valve, a distributed control system, or an independent measuring system.

5. The method of claim 1, wherein the data is used to determine a valve signature, the data including checks of the control valve, including one or more of a valve stem position measurement, an air supply pressure measurement, and an actuator air pressure measurement.

6. The method of claim 5, wherein determining the valve signature is performed over a span of travel of the control valve and wherein one or more tests are used to detect galling in the control valve by observing stiction in the data associated with the control valve.

7. The method of claim 1, wherein the data is obtained using one or more tests, the one or more tests including at least one of an alternating step test, a same direction step test, a step speed test, a hysteresis test, and a deadband test.

8. The method of claim 7, wherein the one or more tests are performed over a span of travel of the control valve and the one or more tests are used to detect galling in the control valve by observing stiction in the data associated with the control valve.

9. The method of claim 8, wherein stiction is observed by comparing a first measurement relative to a second measurement and determining stair-stepping in a result of the comparison of the first measurement relative to the second measurement.

10. The method of claim 1, wherein the analysis comprises one or more of identifying a root cause of an issue associated with the control valve, prioritizing investigation steps associated with the issue, determining an improvement path associated with the issue, estimating a severity of the issue, determining a level of invasiveness associated with the improvement path, and determining an alert associated with the issue to include in the report.

11. The method of claim 10, wherein the analysis comprises performing a correlation between the issue and one or more additional issues to eliminate at least one root cause.

12. The method of claim 11, wherein the analysis further comprises sorting the issue and the one or more additional issues according to an estimated severity of the issue and the one or more additional issues.

13. The method of claim 1, wherein the analysis is performed and the report is generated in real-time.

14. The method of claim 1, further comprising transmitting a first portion of the report to a first entity and transmitting a second portion of the report to a second entity, wherein the first entity is operable to identify one or more optimization operations to provide the second entity to optimize performance of the control valve.

15. The method of claim 1, wherein the information includes at least one of an issue priority, a graph associated with an output of the control valve, diagnostic information, investigation steps, one or more recommended improvements, likelihood of successful impact, and diagnostic aids.

16. The method of claim 1, wherein the analysis comprises comparing the data from a first measurement associated with the control valve relative to the data from a second measurement associated with the control valve.

17. A system comprising:
a control valve;
one or more sensors configured to obtain data associated with the control valve; and
a computing device processor configured to:
perform an analysis corresponding to the control valve using at least the data, and
generate a report using the analysis, the report including information associated with the control valve.

18. The system of claim 17, wherein the computing device processor is further configured to:
obtain an input from a user to confirm the user viewed the report and a correctness of the report; and
implement an improvement path detailed in the report to repair the control valve and not repair a second control valve of a plurality of control valves.

19. The system of claim 17, wherein the data is obtained using one or more tests, the one or more tests including at least one of an alternating step test, a same direction step test, a step speed test, a hysteresis test, and a deadband test.

20. The system of claim 17, wherein the analysis comprises one or more of identifying a root cause of an issue associated with the control valve, prioritizing investigation steps associated with the issue, determining an improvement path associated with the issue, estimating a severity of the issue, determining a level of invasiveness associated with the improvement path, and determining an alert associated with the issue to include in the report.

21. The system of claim 17, wherein the analysis is performed and the report is generated in real-time.

22. A system for providing an experience comprising:
a processor;
a non-transitory computer-readable medium; and
stored instructions translatable by the processor to perform:
obtaining, using one or more sensors associated with a control valve, data associated with the control valve,
performing an analysis corresponding to the control valve using at least the data obtained, and
generating a report using the analysis, the report including information associated with the control valve.

23. The system of claim 22, further comprising obtaining an input from a user to confirm the user viewed the report and a correctness of the report.

24. The system of claim 22, further comprising implementing an improvement path detailed in the report to repair the control valve and not repair a second control valve of a plurality of control valves.

25. The system of claim 22, wherein the one or more sensors are traceable-calibration sensors that are located in at least one of: the control valve, a distributed control system, or an independent measuring system.

26. The system of claim 22, wherein the data is used to determine a valve signature, the data including checks of the control valve, including one or more of a valve stem position measurement, an air supply pressure measurement, and an actuator air pressure measurement.

27. The system of claim 26, wherein determining the valve signature is performed over a span of travel of the control valve and wherein one or more tests are used to detect galling in the control valve by observing stiction in the data associated with the control valve.

28. The system of claim 22, wherein the data is obtained using one or more tests, the one or more tests including at least one of an alternating step test, a same direction step test, a step speed test, a hysteresis test, and a deadband test.

29. The system of claim 28, wherein the one or more tests are performed over a span of travel of the control valve.

30. The system of claim 28, wherein the one or more tests are used to detect galling in the control valve by observing stiction in the data associated with the control valve.

31. The system of claim 30, wherein stiction is observed by comparing a positioner measurement relative to a shaft measurement and determining stair-stepping in a result of the comparison of the positioner measurement relative to the shaft measurement.

32. The system of claim 22, wherein the analysis comprises one or more of identifying a root cause of an issue associated with the control valve, prioritizing investigation steps associated with the issue, determining an improvement path associated with the issue, estimating a severity of the issue, determining a level of invasiveness associated with the improvement path, and determining an alert associated with the issue to include in the report.

33. The system of claim 32, wherein the analysis comprises performing a correlation between the issue and one or more additional issues to eliminate at least one root cause.

34. The system of claim 33, wherein the analysis further comprises sorting the issue and the one or more additional issues according to the estimated severity of the issue and the one or more additional issues.

35. The system of claim 22, wherein the analysis is performed and the report is generated in real-time.

36. The system of claim 22, further comprising transmitting a first portion of the report to a first entity and transmitting a second portion of the report to a second entity, wherein the first entity is operable to identify one or more optimization operations to provide the second entity to optimize performance of the control valve.

37. The system of claim 22, wherein the information includes at least one of an issue priority, a graph associated with an output of the control valve, diagnostic information, investigation steps, one or more recommended improvements, likelihood of successful impact, and diagnostic aids.
